(19) United States
(12) Patent Application Publication
(10) Pub. No.: US 2024/0263679 A1
(43) Pub. Date: Aug. 8, 2024

(54) DISC BRAKE AND PAD SPRING

(71) Applicant: HITACHI ASTEMO, LTD., Ibaraki (JP)

(72) Inventors: Aoi NAKANOME, Hitachinaka-shi (JP); Shoichi NOGUCHI, Hitachinaka-shi (JP); Shigeru HAYASHI, Hitachinaka-shi (JP)

(21) Appl. No.: 18/567,066

(22) PCT Filed: Jun. 6, 2022
(86) PCT No.: PCT/JP2022/022791

§ 371 Date: Dec. 5, 2023

(30) Foreign Application Priority Data
Jun. 11, 2021 (JP) 2021-097826

(51) Int. Cl. F16D 65/097; F16D 55/225; F16D 65/00

(52) U.S. Cl. CPC F16D 65/097; F16D 55/225; F16D 65/0068

(57) ABSTRACT

This disc brake includes a mounting member fixed to a non-rotating portion of a vehicle and provided to straddle an outer circumferential side of a disc, a caliper provided on the mounting member to be movable in an axial direction of the disc, a pair of friction pads provided on the mounting member to be movable and pressed against both sides of the disc by the caliper, and a pair of pad springs provided on the mounting member. At least one of the pair of pad springs includes a pad support part supporting the friction pads, and a suppression part suppressing at least one of movement of the caliper in a rotation direction of the disc and movement of the caliper in a radial direction of the disc.

### TECHNICAL FIELD

The present invention relates to a disc brake and a pad spring.

Priority is claimed on Japanese Patent Application No. 2021-097826 filed on Jun. 11, 2021, the contents of which are incorporated herein by reference.

### BACKGROUND ART

A technology in which rattling of a caliper body when a vehicle travels or brakes is suppressed by elastically supporting a reaction claw of the caliper body with a retainer has been disclosed (for example, see Patent Document 1).

### CITATION LIST

### Patent Document

[Patent Document 1]

Japanese Unexamined Patent Application, First Publication No. 2000-227131

### SUMMARY OF INVENTION

### Technical Problem

In the above-described disc brake, a retainer attached to a caliper bracket elastically supports a center of the reaction claw of the caliper body. Therefore, a load applied to the retainer increases, and there has been a likelihood that durability of the retainer, and furthermore, durability of the disc brake will decrease.

An objective of the present invention is to provide a disc brake and a pad spring that can suppress a decrease in durability.

### Solution to Problem

A disc brake according to a first aspect of the present invention includes a mounting member fixed to a non-rotating portion of a vehicle and provided to straddle an outer circumferential side of a disc, a caliper provided on the mounting member to be movable in an axial direction of the disc, a pair of friction pads provided on the mounting member to be movable and pressed against both sides of the disc by the caliper, and a pair of pad springs provided on the mounting member, in which at least one of the pair of pad springs includes a pad support part supporting the friction pads, and a suppression part suppressing at least one of movement of the caliper in a rotation direction of the disc and movement of the caliper in a radial direction of the disc.

A disc brake according to a second aspect of the present invention includes a mounting member fixed to a non-rotating portion of a vehicle and provided to straddle an outer circumferential side of a disc, a caliper provided on the mounting member to be movable in an axial direction of the disc, a pair of friction pads provided on the mounting member to be movable and pressed against both sides of the disc by the caliper, a first suppression member provided on the mounting member at one end side of the friction pads in a longitudinal direction and configured to suppress at least one of movement of the caliper in a rotation direction of the disc and movement of the caliper in a radial direction of the disc, and a second suppression member provided on the mounting member at the other end side of the friction pads in the longitudinal direction and configured to suppress at least one of movement of the caliper in the rotation direction of the disc and movement of the caliper in the radial direction of the disc.

A pad spring according to a third aspect of the present invention is provided on a mounting member in a disc brake including the mounting member fixed to a non-rotating portion of a vehicle and provided to straddle an outer circumferential side of a disc, a caliper provided on the mounting member to be movable in an axial direction of the disc, and a pair of friction pads provided on the mounting member to be movable and pressed against both sides of the disc by the caliper, and the pad spring includes a pad support part supporting the friction pads, and a suppression part suppressing at least one of movement of the caliper in a rotation direction of the disc and movement of the caliper in a radial direction of the disc.

### Advantageous Effects of Invention

According to each of the above-described aspects of the present invention, it is possible to suppress a decrease in durability.

### BRIEF DESCRIPTION OF DRAWINGS

FIG. 1 is a plan view showing a disc brake of a first embodiment.

FIG. 2 is a perspective view showing the disc brake of the first embodiment.

FIG. 3 is a perspective view showing the disc brake of the first embodiment.

FIG. 4 is a cross-sectional view of a main part showing the disc brake of the first embodiment.

FIG. 5 is a cross-sectional view of a main part showing the disc brake of the first embodiment.

FIG. 6 is a perspective view showing a pad spring of the disc brake of the first embodiment.

FIG. 7 is a cross-sectional view of a main part showing a disc brake of a second embodiment.

FIG. 8 is a cross-sectional view of a main part showing a disc brake of a third embodiment.

FIG. 9 is a perspective view showing a pad spring of the disc brake of the third embodiment.

FIG. 10 is a perspective view showing a pad spring of a disc brake of a fourth embodiment.

### DESCRIPTION OF EMBODIMENTS

### First Embodiment

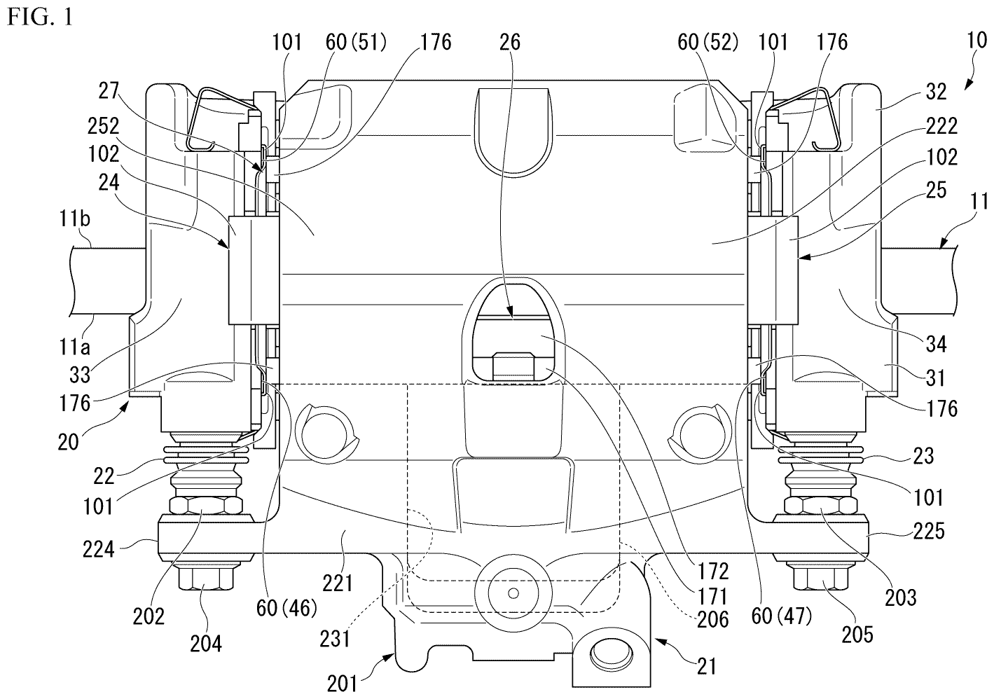

A first embodiment will be described below with reference to FIGS. 1 to 6. A disc brake 10 of the first embodiment shown in FIGS. 1 to 3 is for a vehicle such as an automobile and applies a braking force to a vehicle. The disc brake 10 is specifically used for braking a four-wheeled vehicle. The disc brake 10 brakes a vehicle by stopping rotation of a disc-shaped disc 11 that rotates together with a wheel (not shown).

As shown in FIG. 1, the disc brake 10 includes a mounting member 20, a caliper 21, and a pair of a first pin boot 22 and a second pin boot 23. Also, the disc brake 10 includes a pair of a first pad spring 24 (a pad spring, for example, a first pad spring, and for example, a first suppression member) and a second pad spring 25 (a pad spring, for example, a second pad spring, and for example, a second suppression member). Also, the disc brake 10 includes a pair of a first friction pad 26 and a second friction pad 27.

Hereinafter, a central axis of the disc 11 is referred to as a disc axis. Also, a direction in which the disc axis extends is referred to as a disc axial direction. A radial direction of the disc 11 in the disc brake 10 is referred to as a disc radial direction. A rotation direction of the disc 11 in the disc brake 10, that is, a circumferential direction thereof, is referred to as a disc rotation direction. A center side of the disc 11 in the disc radial direction is referred to as a disc radial direction inner side. A side opposite to the center of the disc 11 in the disc radial direction is referred to as a disc radial direction outer side. A center side of a length in the disc rotation direction in the disc brake 10 is referred to as a disc rotation direction inner side. A side opposite to a center of the length in the disc rotation direction in the disc brake 10 is referred to as a disc rotation direction outer side. A line passing through the disc axis and a center of the mounting member 20 and the caliper 21 in the disc rotation direction, and extending in the disc radial direction is referred to as a radial direction reference line. The radial direction reference line is orthogonal to the disc axis. A plane including the radial direction reference line and the disc axis is referred to as a radial direction reference plane. An outer side in a vehicle width direction of the vehicle in which the disc brake 10 is provided is referred to as an outer side. An inner side in the vehicle width direction of the vehicle in which the disc brake 10 is provided is referred to as an inner side. One end side in the rotation direction of the disc 11 in the disc brake 10 in a first rotation direction of the disc 11 is referred to as a disc rotation direction first end side. The other end side in the rotation direction of the disc 11 in the disc brake 10 in the same first rotation direction of the disc 11 is referred to as a disc rotation direction second end side,

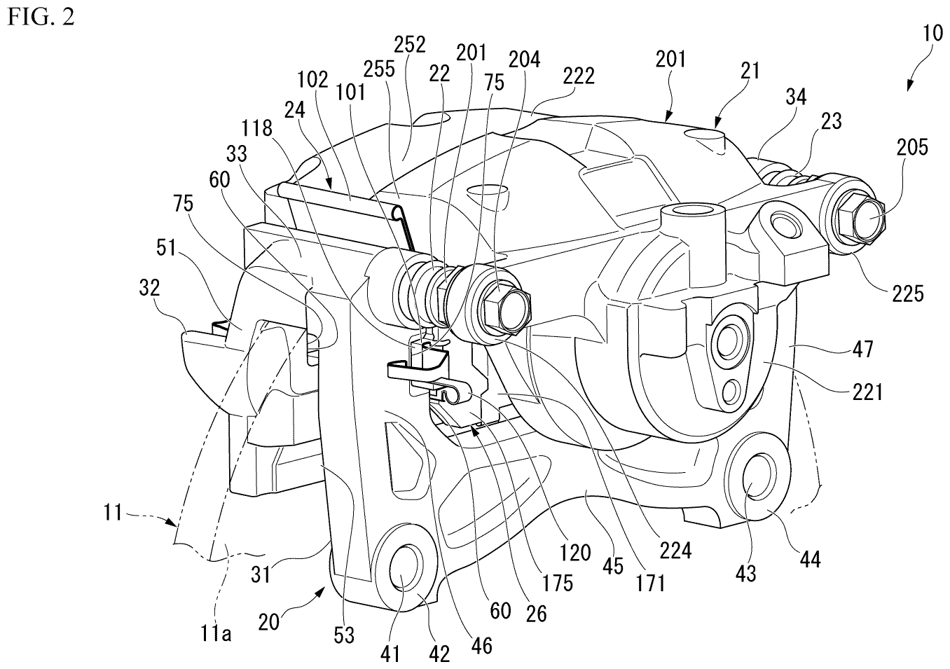

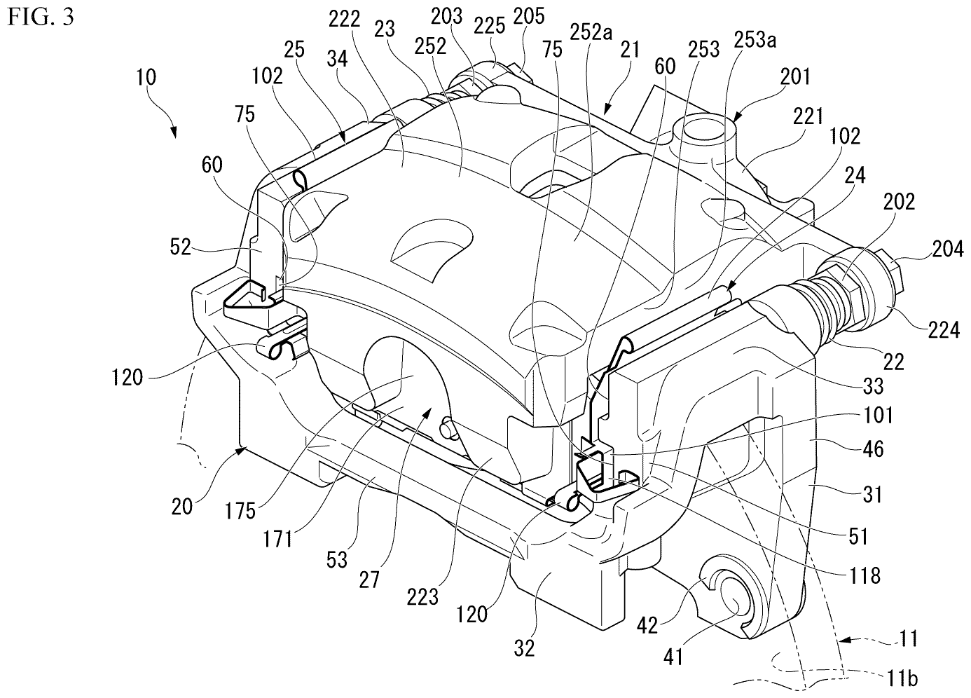

As shown in FIGS. 2 and 3, the mounting member 20 is provided on the vehicle to straddle an outer circumferential side of the disc 11. The mounting member 20 is fixed to a non-rotating portion of the vehicle in this state. The mounting member 20 includes an inner disposition part 31, an outer disposition part 32, and a pair of a first coupling part 33 and a second coupling part 34 that connect them. The mounting member 20 has a substantially mirror-symmetrical shape with respect to the radial direction reference plane. In other words, the radial direction reference plane passes through a center position of the mounting member 20 in the disc rotation direction.

As shown in FIG. 1, the disc 11 has a first braking surface 11a on one side in the disc axial direction and a second braking surface 11b on the other side in the disc axial direction. The first braking surface 11a is disposed on the inner side of the disc 11. The second braking surface 11b is disposed on the outer side of the disc 11.

The inner disposition part 31 is disposed on one side of the disc 11 in the disc axial direction and is attached to the non-rotating portion of the vehicle. Here, the non-rotating portion of the vehicle to which the mounting member 20 is attached is disposed on the inner side with respect to the disc 11. Therefore, the inner disposition part 31 attached to this non-rotating portion is also disposed on the inner side with respect to the disc 11. As shown in FIG. 2, the inner disposition part 31 faces the first braking surface 11a of the disc 11. The inner disposition part 31 supports the first friction pad 26 to be movable. The first friction pad 26 is disposed on the inner side with respect to the disc 11. The first friction pad 26 is disposed to face the first braking surface 11a of the disc 11.

As shown in FIG. 3, the outer disposition part 32 is disposed on the other side with respect to the disc 11 in the disc axial direction. The outer disposition part 32 is disposed on the outer side with respect to the disc 11. The outer disposition part 32 faces the second braking surface 11b of the disc 11. The outer disposition part 32 supports the second friction pad 27 to be movable. The second friction pad 27 is disposed on the outer side with respect to the disc 11. The second friction pad 27 is disposed to face the second braking surface 11b of the disc 11.

The first coupling part 33 and the second coupling part 34 extend in the disc axial direction, and are provided to straddle the outer circumferential side of the disc 11 in the disc axial direction. The first coupling part 33 connects end portions of the inner disposition part 31 and the outer disposition part 32 on the outer side in the disc radial direction and on the disc rotation direction first end side. The second coupling part 34 connects end portions of the inner disposition part 31 and the outer disposition part 32 on the outer side in the disc radial direction and on the disc rotation direction second end side.

As shown in FIG. 2, the inner disposition part 31 includes a first fixing part 42 having a screw hole 41, a second fixing part 44 having a screw hole 43, and a main beam 45 connecting the first fixing part 42 and the second fixing part 44. Also, the inner disposition part 31 includes a first connection part 46 extending from the first fixing part 42 and a second connection part 47 extending from the second fixing part 44. The first fixing part 42, the second fixing part 44, the main beam 45, the first connection part 46, and the second connection part 47 are all disposed on the inner side of the disc 11, and all face the first braking surface 11a of the disc 11.

The first fixing part 42 is provided at an end portion of the inner disposition part 31 on the disc rotation direction first end side. The second fixing part 44 is provided at an end portion of the inner disposition part 31 on the disc rotation direction second end side. The main beam 45 extends in the disc rotation direction. The screw hole 41 is bored through the first fixing part 42 in the disc axial direction. The screw hole 43 is bored through the second fixing part 44 in the disc axial direction. In a state in which the first fixing part 42 and the second fixing part 44 are abutted against a mounting portion (not shown) that is of a non-rotating portion of the vehicle, the mounting member 20 is mounted on the mounting portion by bolts that are screwed into the screw holes 41 and 43. The first fixing part 42 and the second fixing part 44 fixed to the non-rotating portion of the vehicle are aligned with each other in position in the disc axial direction. In this state, the main beam 45 overlaps the first fixing part 42 and the second fixing part 44 in position in the disc axial direction.

The first connection part 46 overlaps the first fixing part 42 in position in the disc axial direction and extends toward the disc radial direction outer side from the first fixing part 42. The second connection part 47 overlaps the second fixing part 44 in position in the disc axial direction and extends toward the disc radial direction outer side from the second fixing part 44. The first connection part 46 is disposed on the disc rotation direction first end side with respect to the second connection part 47.

The first coupling part 33 extends from an end portion of the first connection part 46 on the disc radial direction outer side toward the outer side in the disc axial direction to straddle the disc radial direction outer side with respect to an outer circumferential surface of the disc 11. The second coupling part 34 extends from an end portion of the second connection part 47 on the disc radial direction outer side toward the outer side in the disc axial direction to straddle the disc radial direction outer side with respect to the outer circumferential surface of the disc 11 as shown in FIG. 1. Both the first coupling part 33 and the second coupling part 34 are portions of the mounting member 20 that straddle the outer circumferential side of the disc 11.

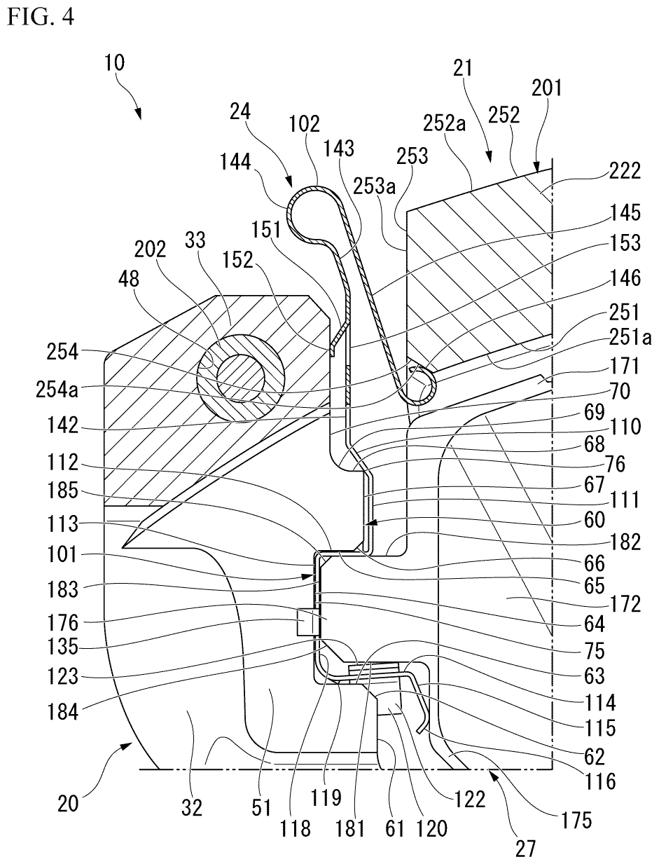

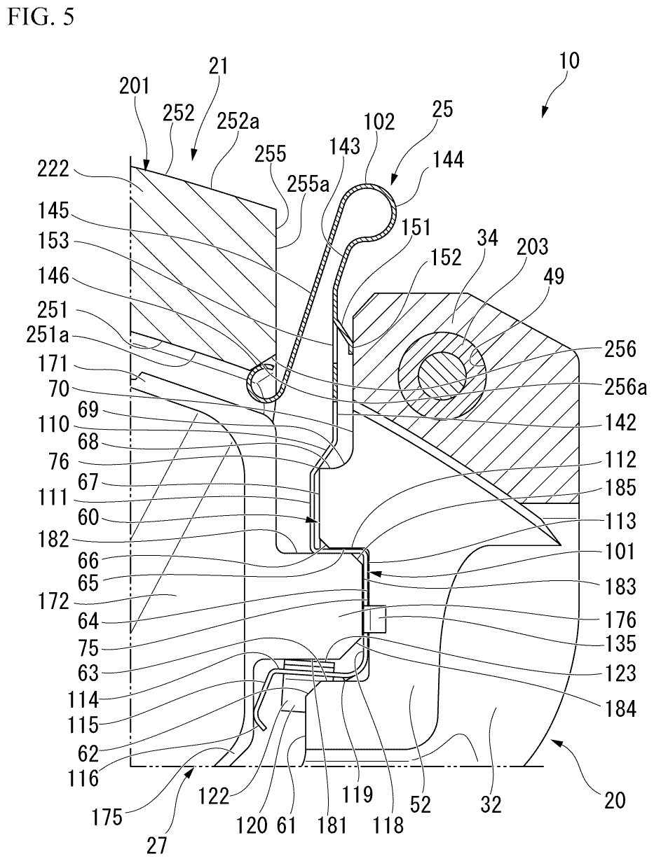

A first pin insertion hole 48 is formed in the first coupling part 33 as shown in FIG. 4. The first pin insertion hole 48 extends in the disc axial direction. The first pin insertion hole 48 is formed from an end surface on the inner side of the first coupling part 33 to an intermediate position within the first coupling part 33. A second pin insertion hole 49 is formed in the second coupling part 34 as shown in FIG. 5. Similarly to the first pin insertion hole 48, the second pin insertion hole extends in the disc axial direction, and is formed from an end surface on the inner side of the second coupling part 34 to an intermediate position within the second coupling part 34.

As shown in FIG. 3, the outer disposition part 32 includes a third connection part 51 extending from the first coupling part 33, a fourth connection part 52 extending from the second coupling part 34, and an outer beam 53 connecting the third connection part 51 and the fourth connection part 52. The third connection part 51, the fourth connection part 52, and the outer beam 53 are all disposed on the outer side of the disc 11, and all face the second braking surface 11b of the disc 11.

The third connection part 51 extends inward in the disc radial direction from an end portion on the outer side of the first coupling part 33 in the disc axial direction. The fourth connection part 52 extends inward in the disc radial direction from an end portion on the outer side of the second coupling part 34 in the disc axial direction. The third connection part 51 is disposed on the disc rotation direction first end side with respect to the fourth connection part 52. The outer beam 53 connects an end portion of the third connection part 51 on the disc radial direction inner side and an end portion of the fourth connection part 52 on the disc radial direction inner side. The outer beam 53 extends in the disc rotation direction.

As shown in FIG. 1, the first connection part 46, the second connection part 47, the third connection part 51, and the fourth connection part 52 each have an engaging part 60 having a similar shape on the disc rotation direction inner side. The engaging part 60 of the first connection part 46 and the engaging part 60 of the second connection part 47 are disposed in a mirror-symmetrical shape. The engaging part 60 of the third connection part 51 and the engaging part 60 of the fourth connection part 52 are disposed in a mirror-symmetrical shape.

The engaging part 60 will be described by taking the engaging part 60 of the third connection part 51 shown in FIG. 4 as an example. The engaging part 60 includes a first surface portion 61, a second surface portion 62, a third surface portion 63, a fourth surface portion 64, a fifth surface portion 65, a sixth surface portion 66, a seventh surface portion 67, an eighth surface portion 68, a ninth surface portion 69, and a tenth surface portion 70 in order from the disc radial direction inner side. The first surface portion 61, the second surface portion 62, the third surface portion 63, the fourth surface portion 64, the fifth surface portion 65, the sixth surface portion 66, the seventh surface portion 67, the eighth surface portion 68, the ninth surface portion 69, and the tenth surface portion 70 all extend in the disc axial direction.

The first surface portion 61 has a planar shape and extends parallel to the radial direction reference plane.

The second surface portion 62 has a planar shape and extends from an end edge portion on the disc radial direction outer side of the first surface portion 61 to the disc radial direction outer side and disc rotation direction outer side.

The third surface portion 63 has a planar shape and extends from an end edge portion on the disc radial direction outer side of the second surface portion 62 to the disc rotation direction outer side. The third surface portion 63 extends perpendicular to the radial direction reference plane.

The fourth surface portion 64 has a planar shape and extends from an end edge portion on the disc rotation direction outer side of the third surface portion 63 to the disc radial direction outer side. The fourth surface portion 64 extends parallel to the radial direction reference plane.

The fifth surface portion 65 has a planar shape and extends from an end edge portion on the disc radial direction outer side of the fourth surface portion 64 to the disc rotation direction inner side. The fifth surface portion 65 extends perpendicular to the radial direction reference plane.

The sixth surface portion 66 has a planar shape and extends to be inclined with respect to the fifth surface portion 65 from an end edge portion on the disc rotation direction inner side of the fifth surface portion 65. The sixth surface portion 66 extends from the fifth surface portion 65 so that it is positioned further away from the third surface portion 63 in the disc radial direction and further toward the disc rotation direction inner side with distance away from the fifth surface portion 65.

The seventh surface portion 67 has a planar shape and extends from an end edge portion on the disc rotation direction inner side of the sixth surface portion 66 to the disc radial direction outer side. The seventh surface portion 67 extends parallel to the radial direction reference plane.

The eighth surface portion 68 has a planar shape and extends from an end edge portion on the disc radial direction outer side of the seventh surface portion 67 to the disc rotation direction outer side. The eighth surface portion 68 extends perpendicular to the radial direction reference plane.

The ninth surface portion 69 has a curved surface shape and extends from an end edge portion on the disc rotation direction outer side of the eighth surface portion 68 to the disc radial direction outer side and the disc rotation direction outer side.

The tenth surface portion 70 has a planar shape and extends from an end edge portion on the disc radial direction outer side of the ninth surface portion 69 to the disc radial direction outer side. The tenth surface portion 70 extends parallel to the radial direction reference plane.

The second surface portion 62, the third surface portion 63, the fourth surface portion 64, the fifth surface portion 65, and the sixth surface portion 66 that are continuous with each other form an engagement recessed part 75 that is recessed to the disc rotation direction outer side with respect to the first surface portion 61 and the seventh surface portion 67. The seventh surface portion 67 and the eighth surface portion 68 form a corner portion 76 at their boundary position.

As shown in FIG. 5, the engaging part 60 of the fourth connection part 52 includes a first surface portion 61, a second surface portion 62, a third surface portion 63, a fourth surface portion 64, a fifth surface portion 65, a sixth surface portion 66, a seventh surface portion 67, an eighth surface portion 68, a ninth surface portion 69, a tenth surface portion 70, an engagement recessed part 75, and a corner portion 76, all of which are the same as those of the engaging part 60 of the third connection part 51 shown in FIG. 4.

The engagement recessed part 75 of the third connection part 51 shown in FIG. 4 and the engagement recessed part 75 of the fourth connection part 52 shown in FIG. 5 face each other in the disc rotation direction and are recessed in a direction away from each other in the disc rotation direction. The engagement recessed part 75 of the third connection part 51 and the engagement recessed part 75 of the fourth connection part 52 are aligned in position in the disc axial direction and are also aligned in position in the disc radial direction. The corner portion 76 of the third connection part 51 and the corner portion 76 of the fourth connection part 52 are aligned in position in the disc axial direction and are also aligned in position in the disc radial direction. The engagement recessed part 75 of the third connection part 51 penetrates the third connection part 51 in the disc axial direction. The engagement recessed part 75 of the fourth connection part 52 penetrates the fourth connection part 52 in the disc axial direction.

Similarly to the third connection part 51 and the fourth connection part 52, the engagement recessed part 75 of the first connection part 46 shown in FIG. 2 and an engagement recessed part (not shown) of the second connection part 47 face each other in the disc rotation direction and are recessed in a direction away from each other in the disc rotation direction. Similarly to the third connection part 51 and the fourth connection part 52, the engagement recessed part 75 of the first connection part 46 and the engagement recessed part (not shown) of the second connection part 47 are aligned in position in the disc axial direction and are also aligned in position in the disc radial direction. Similarly to the third connection part 51 and the fourth connection part 52, the corner portion (not shown) of the first connection part 46 and the corner portion (not shown) of the second connection part 47 are aligned in position in the disc axial direction and are also aligned in position in the disc radial direction. Similarly to the third connection part 51 and the fourth connection part 52, the engagement recessed part 75 of the first connection part 46 penetrates the first connection part 46 in the disc axial direction. Similarly to the third connection part 51 and the fourth connection part 52, the engagement recessed part (not shown) of the second connection part 47 penetrates the second connection part 47 in the disc axial direction.

The engagement recessed part 75 of the third connection part 51 shown in FIG. 3 and the engagement recessed part 75 of the first connection part 46 shown in FIG. 2 are aligned in position in the disc radial direction and are also aligned in position in the disc rotation direction. The engagement recessed part 75 of the fourth connection part 52 shown in FIG. 3 and the engagement recessed part (not shown) of the second connection part 47 are aligned in position in the disc radial direction and are also aligned in position in the disc rotation direction.

In the mounting member 20, the inner disposition part 31 supports the first friction pad 26 with the engagement recessed part 75 provided in the first connection part 46 shown in FIG. 2 and the engagement recessed part (not shown) provided in the second connection part 47. Also, in the mounting member 20, the outer disposition part 32 supports the second friction pad 27 with the engagement recessed part 75 provided in the third connection part 51 shown in FIG. 3 and the engagement recessed part 75 provided in the fourth connection part 52. In the mounting member 20, the first fixing part 42, the first connection part 46, the first coupling part 33, and the third connection part 51, which are shown in FIG. 2, are disposed on the disc rotation direction first end side. In the mounting member 20, the second fixing part 44, the second connection part 47, the second coupling part 34, and the fourth connection part 52 shown in FIG. 3 are disposed on the disc rotation direction second end side.

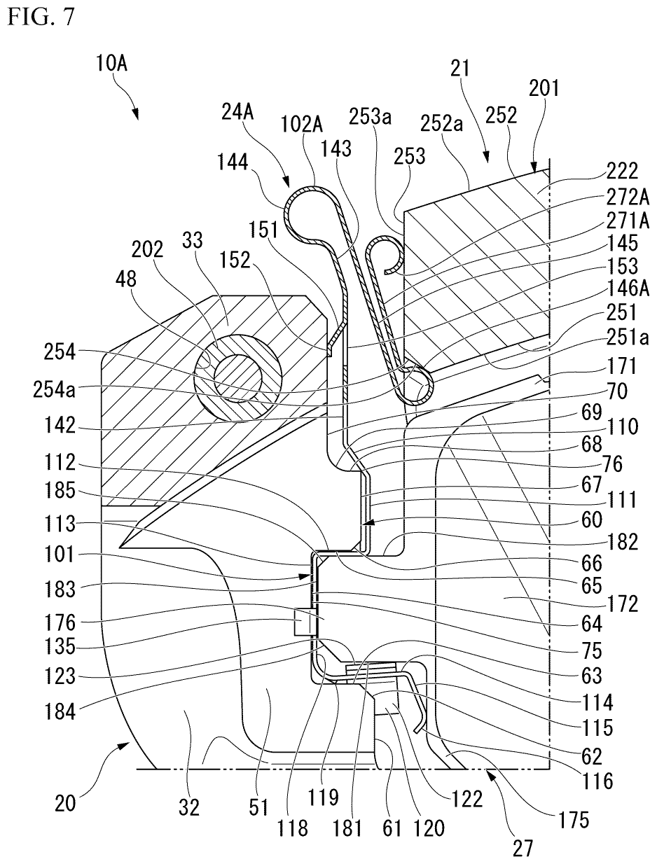

Both the first pad spring 24 and the second pad spring 25 are provided integrally with the mounting member 20. The first pad spring 24 and the second pad spring 25 are common parts having the same shape. The first pad spring 24 is attached to the disc rotation direction first end side of the mounting member 20. At that time, one first pad spring 24 is attached across both the first connection part 46 and the third connection part 51, both of which are on the disc rotation direction first end side. The second pad spring 25 is attached to the disc rotation direction second end side of the mounting member 20. At that time, one second pad spring 25 is attached across both the second connection part 47 shown in FIG. 7 and the fourth connection part 52 shown in FIG. 3, both of which are on the disc rotation direction second end side. That is, two of the first pad spring 24 and the second pad spring 25 are attached to one mounting member 20. The first pad spring 24 and the second pad spring 25 are provided on the mounting member 20 to elastically support the first friction pad 26 shown in FIG. 2 and the second friction pad 27 shown in FIG. 3. The first pad spring 24 and the second pad spring 25 guide movement of the first friction pad 26 and the second friction pad 27 in the disc axial direction.

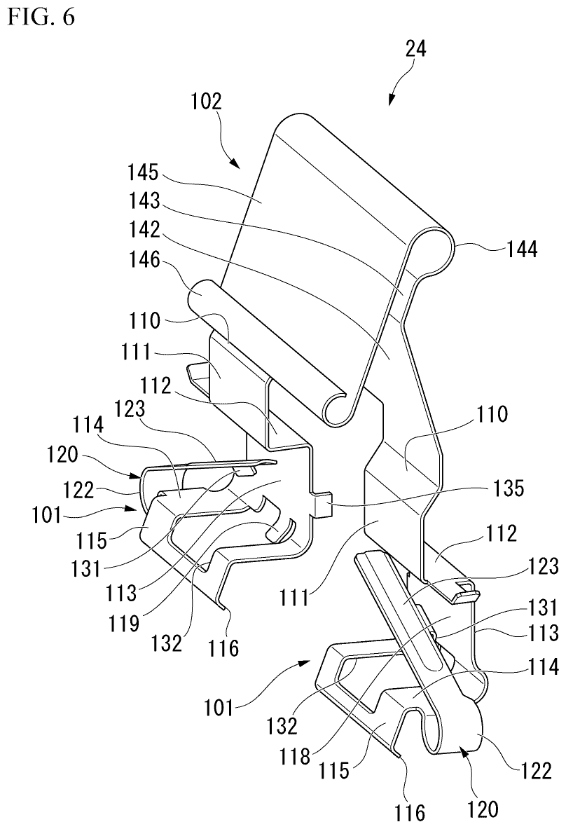

The first pad spring 24 and the second pad spring 25 are common parts having the same shape. Here, the first pad spring 24 will be taken as an example and described on the basis of FIG. 6. FIG. 6 shows the first pad spring 24 in a natural state before being assembled to the mounting member 20.

The first pad spring 24 has a mirror-symmetrical shape. The first pad spring 24 is formed by press-forming a single sheet of a metal plate material having a constant thickness. The first pad spring 24 has a pair of pad support parts 101 and a suppression part 102 connecting the pad support parts 101. In the first pad spring 24, the pair of pad support parts 101 are disposed on both sides of the disc 11 in the disc axial direction, and the suppression part 102 is disposed on the disc radial direction outer side with respect to the disc 11. In other words, the disc 11 is disposed between the pair of pad support parts 101 of the first pad spring 24.

In one first pad spring 24, the pair of pad support parts 101 have a mirror-symmetrical shape. Therefore, one of the pad support parts 101 will be described.

The pad support part 101 includes an outer end plate part 110, an outer plate part 111, an outer support plate part 112, a wall plate part 113, an extension plate part 114, an inner plate part 115, and an inner end plate part 116. The outer end plate part 110, the outer plate part 111, the outer support plate part 112, the wall plate part 113, the extension plate part 114, the inner plate part 115, and the inner end plate part 116 all have a flat plate shape.

The outer end plate part 110 is an end portion of the pad support part 101 on the suppression part 102 side.

The outer plate part 111 extends from an end edge portion of the outer end plate part 110 on a side opposite to the suppression part 102 to a side opposite to the suppression part 102 at an obtuse angle with respect to the outer end plate part 110.

The outer support plate part 112 extends perpendicular to the outer plate part 111 from an end edge portion of the outer plate part 111 on a side opposite to the outer end plate part 110. The outer support plate part 112 extends from the outer plate part 111 to the same side as the outer end plate part 110 in a thickness direction of the outer plate part 111.

The wall plate part 113 extends perpendicular to the outer support plate part 112 from an end edge portion of the outer support plate part 112 on a side opposite to the outer plate part 111. The wall plate part 113 extends from the outer support plate part 112 to a side opposite to the outer plate part 111 in a thickness direction of the outer support plate part 112.

The extension plate part 114 extends from an end edge portion of the wall plate part 113 on a side opposite to the outer support plate part 112 at an acute angle with respect to the wall plate part 113. The extension plate part 114 extends from the wall plate part 113 to the same side as the outer support plate part 112 in a thickness direction of the wall plate part 113.

The inner plate part 115 extends from an end edge portion of the extension plate part 114 on a side opposite to the wall plate part 113 at an obtuse angle with respect to the extension plate part 114. The inner plate part 115 extends from the extension plate part 114 to a side opposite to the wall plate part 113 in a thickness direction of the extension plate part 114.

The inner end plate part 116 extends from an end edge portion of the inner plate part 115 on a side opposite to the extension plate part 114 at an obtuse angle with respect to the inner plate part 115. The inner end plate part 116 extends from the inner plate part 115 to the same side as the extension plate part 114 in a thickness direction of the inner plate part 115.

The outer end plate part 110 extends from the outer plate part 111 to a side opposite to the outer support plate part 112 in the thickness direction of the outer support plate part 112.

A boundary line between the outer end plate part 110 and the outer plate part 111, a boundary line between the outer plate part 111 and the outer support plate part 112, a boundary line between the outer support plate part 112 and the wall plate part 113, a boundary line between the wall plate part 113 and the extension plate part 114, a boundary line between the extension plate part 114 and the inner plate part 115, and a boundary line between the inner plate part 115 and the inner end plate part 116 are parallel to each other. The outer plate part 111 and the wall plate part 113 extend parallel to each other. The extension plate part 114 extends to be inclined with respect to the outer support plate part 112 so that it comes closer to the outer support plate part 112 with distance away from the wall plate part 113. In other words, a distance between the outer support plate part 112 and the extension plate part 114 reduces with distance away from the wall plate part 113.

The outer support plate part 112, the wall plate part 113, and the extension plate part 114 that are continuous with each other are connected in a recessed shape as a whole to form a guide recessed part 118. The guide recessed part 118 has an engaging claw 119. The engaging claw 119 protrudes from the wall plate part 113 to a side opposite to the outer support plate part 112 with respect to the extension plate part 114. The engaging claw 119 protrudes from the wall plate part 113 at an obtuse angle with respect to the wall plate part 113. The engaging claw 119 protrudes on the same side as the extension plate part 114 with respect to the wall plate part 113 in the thickness direction of the wall plate part 113.

The pad support part 101 has a spring plate part 120. The spring plate part 120 extends from an end edge portion of the extension plate part 114 of the pad support part 101 on a side opposite to the other pad support part 101 to a side opposite to the other pad support part 101, and then is folded back to the outer support plate part 112 side to extend to the other pad support part 101 side. The spring plate part 120 is positioned on the outer support plate part 112 side with respect to the extension plate part 114 on a base end side thereof.

The spring plate part 120 has a curl plate part 122 and an inner support plate part 123. The curl plate part 122 is curved in a cylindrical shape. In one of the pad support parts 101, the curl plate part 122 extends from an end edge portion of the extension plate part 114 on a side opposite to the other pad support part 101. In one of the pad support part 101, the curl plate part 122 extends from the extension plate part 114 in a direction away from the other pad support part 101 while being separated from the outer support plate part 112 in the thickness direction of the extension plate part 114. Thereafter, the curl plate part 122 extends in a direction away from the other pad support part 101 while approaching the outer support plate part 112 in the thickness direction of the extension plate part 114. Thereafter, the curl plate part 122 extends in a direction toward the other pad support part 101 while approaching the outer support plate part 112 in the thickness direction of the extension plate part 114.

In one of the pad support parts 101, the inner support plate part 123 extends linearly in a direction of the other pad support part 101 from an end edge portion of the curl plate part 122 on a side opposite to an end edge portion continuous with the extension plate part 114. In one of the pad support parts 101, the inner support plate part 123 extends from the curl plate part 122 such that it becomes further away from the extension plate part 114 in the thickness direction of the extension plate part 114 toward the other pad support part 101 side. The spring plate part 120 deforms elastically mainly in the curl plate part 122.

The pad support part 101 has a protruding piece part 131. The protruding piece part 131 is bent from an edge portion of the inner support plate part 123 on the wall plate part 113 side to the extension plate part 114 side. The protruding piece part 131 is bent substantially perpendicular to the inner support plate part 123. The protruding piece part 131 is disposed at an intermediate position of the inner support plate part 123 in a direction in which the inner support plate part 123 extends.

An intermediate opening 132 is formed in the extension plate part 114. The intermediate opening 132 penetrates a predetermined intermediate range of the extension plate part 114 in the thickness direction of the extension plate part 114. The spring plate part 120 elastically deforms in a direction that brings the inner support plate part 123 closer to the extension plate part 114. Then, the protruding piece part 131 enters the inside of the intermediate opening 132 and passes through the extension plate part 114 in the thickness direction.

The pad support part 101 has an engagement protruding part 135. In one of the pad support parts 101, the engagement protruding part 135 protrudes from an end edge portion of the wall plate part 113 on the other pad support part 101 side. The engagement protruding part 135 protrudes from the wall plate part 113 to a side opposite to the outer support plate part 112 and the extension plate part 114 in the thickness direction of the wall plate part 113.

The suppression part 102 includes a base end side plate part 142, an intermediate inclined plate part 143, an intermediate curved plate part 144, an inclined plate part 145, and a contact curved plate part 146.

The base end side plate part 142 extends from end edge portions of the outer end plate parts 110 of the pair of pad support parts 101 on a side opposite to the outer plate part 111. The base end side plate part 142 has a flat plate shape and extends from the pair of outer end plate parts 110 in a direction opposite to the pair of outer plate parts 111 in the thickness direction of the outer support plate part 112. The base end side plate part 142 connects the pair of outer end plate parts 110. The base end side plate part 142 is disposed parallel to the pair of outer plate parts 111.

The intermediate inclined plate part 143 has a flat plate shape and extends from an end edge portion of the base end side plate part 142 on a side opposite to the pair of outer end plate parts 110. The intermediate inclined plate part 143 extends from the base end side plate part 142 to a side opposite to the pair of outer end plate parts 110 in the thickness direction of the outer support plate part 112. The intermediate inclined plate part 143 forms an obtuse angle with respect to the base end side plate part 142. The intermediate inclined plate part 143 extends from the base end side plate part 142 to a side opposite to the pair of outer end plate parts 110 in a thickness direction of the base end side plate part 142.

The intermediate curved plate part 144 has a curved shape to form a cylindrical shape. The intermediate curved plate part 144 extends from an end edge portion of the intermediate inclined plate part 143 on a side opposite to the base end side plate part 142. The intermediate curved plate part 144 extends from the intermediate inclined plate part 143 to the same side as the base end side plate part 142 in a thickness direction of the intermediate inclined plate part 143 while being separated from the outer support plate part 112 in the thickness direction of the outer support plate part 112. Thereafter, the intermediate curved plate part 144 extends such that it approaches the intermediate inclined plate part 143 in the thickness direction of the intermediate inclined plate part 143 while being separated from the outer support plate part 112 in the thickness direction of the outer support plate part 112. Thereafter, the intermediate curved plate part 144 extends to a side opposite to the base end side plate part 142 with respect to the intermediate inclined plate part 143 in the thickness direction of the intermediate inclined plate part 143 while approaching the outer support plate part 112 in the thickness direction of the outer support plate part 112.

The inclined plate part 145 has a flat plate shape and extends from an end edge portion of the intermediate curved plate part 144 on a side opposite to an end edge portion continuous with the intermediate inclined plate part 143. The inclined plate part 145 extends from the intermediate curved plate part 144 in a direction toward the outer support plate part 112 in the thickness direction of the outer support plate part 112. The inclined plate part 145 extends from the intermediate curved plate part 144 in a direction away from the base end side plate part 142 in the thickness direction of the base end side plate part 142. The inclined plate part 145 extends substantially parallel to the intermediate inclined plate part 143.

The contact curved plate part 146 has a curved shape to form a cylindrical shape. The contact curved plate part 146 extends from an end edge portion of the inclined plate part 145 on a side opposite to the intermediate curved plate part 144. The contact curved plate part 146 extends to a side opposite to the intermediate curved plate part 144 in a thickness direction of the inclined plate part 145 while being separated from the intermediate curved plate part 144 in the thickness direction of the outer support plate part 112. Thereafter, the contact curved plate part 146 extends such that it becomes further away from the intermediate curved plate part 144 in the thickness direction of the inclined plate part 145 while approaching the intermediate curved plate part 144 in the thickness direction of the outer support plate part 112. Thereafter, the contact curved plate part 146 extends such that it approaches the intermediate curved plate part 144 in the thickness direction of the inclined plate part 145 while approaching the intermediate curved plate part 144 in the thickness direction of the outer support plate part 112.

Boundary lines between the pair of outer end plate parts 110 and the base end side plate part 142, a boundary line between the base end side plate part 142 and the intermediate inclined plate part 143, a boundary line between the intermediate inclined plate part 143 and the intermediate curved plate part 144, a boundary line between the intermediate curved plate part 144 and the inclined plate part 145, and a boundary line between the inclined plate part 145 and the contact curved plate part 146 are parallel to each other. These boundary lines are parallel to the boundary line between the outer end plate part 110 and the outer plate part 111. These boundary lines are parallel to an axis of a center of curvature of the intermediate curved plate part 144. These boundary lines are parallel to an axis of a center of curvature of the contact curved plate part 146.

As shown in FIG. 4, the suppression part 102 includes a protruding plate part 151 and a contact plate part 152. The protruding plate part 151 has a flat plate shape and protrudes from the base end side plate part 142. The protruding plate part 151 protrudes from the base end side plate part 142 to the same side as the intermediate inclined plate part 143 in the thickness direction of the base end side plate part 142 while being separated from the intermediate inclined plate part 143 in the thickness direction of the outer support plate part 112.

The contact plate part 152 has a flat plate shape and protrudes from a distal end edge portion of the protruding plate part 151 on a protruding side. The contact plate part 152 extends from the protruding plate part 151 in a direction away from the intermediate inclined plate part 143 in the thickness direction of the outer support plate part 112. The contact plate part 152 extends parallel to the base end side plate part 142.

The protruding plate part 151 and the contact plate part 152 are provided at an intermediate portion of the base end side plate part 142. The base end side plate part 142 has an opening 153 that is formed when the protruding plate part 151 and the contact plate part 152 are cut and raised.

As shown in FIG. 1, the first pad spring 24 is attached to the first connection part 46 and the third connection part 51, both of which are on the disc rotation direction first end side of the mounting member 20. At that time, the first pad spring 24 is in a state in which the suppression part 102 is disposed on the disc radial direction outer side with respect to the pad support parts 101 as shown in FIG. 4. Also, at that time, the first pad spring 24 fits the guide recessed part 118 of one of the pad support parts 101 into the engagement recessed part 75 of the third connection part 51, and fits the guide recessed part 118 of the other of the pad support parts 101 into the engagement recessed part 75 of the first connection part 46 as shown in FIG. 2. Thereby, the first pad spring 24 is provided on the mounting member 20 such that movement in the disc radial direction and to the disc rotation direction first end side is restricted. Also, at that time, the first pad spring 24 brings one of the engagement protruding parts 135 shown in FIG. 6 into contact with a surface of the first connection part 46 on the third connection part 51 side, and brings the other of the engagement protruding parts 135 shown in FIG. 4 into contact with a surface of the third connection part 51 on the first connection part 46 side. Thereby, the first pad spring 24 is provided on the mounting member 20 such that movement in the disc axial direction is restricted. In other words, the first pad spring 24 is attached and positioned in the disc radial direction, the disc rotation direction, and the disc axial direction with respect to the mounting member 20.

Thereby, the first pad spring 24 is in a state in which the pair of pad support parts 101 are disposed on both sides of the disc 11 in the disc axial direction as shown in FIG. 1. Also, in this state, the first pad spring 24 is in a state in which the guide recessed part 118 and the spring plate part 120 of one of the pad support parts 101 shown in FIGS. 3 and 4 are disposed in the engagement recessed part 75 of the third connection part 51 on the disc rotation direction first end side of the mounting member 20, and the guide recessed part 118 and the spring plate part 120 of the other of the pad support parts 101 shown in FIG. 2 are disposed in the engagement recessed part 75 of the first connection part 46 on the disc rotation direction first end side of the mounting member 20.

The first pad spring 24 provided on the disc rotation direction first end side in this way has a shape in which the pair of guide recessed parts 118 that fit into the pair of engagement recessed parts 75 are recessed outward in the disc rotation direction while being attached to the first connection part 46 and the third connection part 51.

In the first pad spring 24 in an attached state in which it is attached to the mounting member 20, the outer pad support part 101 shown in FIG. 4 engages with the engaging part 60 of the third connection part 51, and the inner pad support part 101 shown in FIG. 2 engages with the engaging part 60 of the first connection part 46. An engagement state between the outer pad support part 101 and the engaging part 60 of the third connection part 51 shown in FIG. 4 is the same as an engagement state between the inner pad support part 101 and the engaging part 60 of the first connection part 46 shown in FIG. 2. Therefore, here, regarding the first pad spring 24, the engagement state between the outer pad support part 101 and the engaging part 60 of the third connection part 51 will be described on the basis of FIG. 4.

In the outer pad support part 101 of the first pad spring 24, the wall plate part 113 of the guide recessed part 118 is disposed on the disc rotation direction outer side in the guide recessed part 118. At that time, the wall plate part 113 of the guide recessed part 118 faces the fourth surface portion 64 on a back side in a recess direction of the engagement recessed part 75, and makes surface contact with the fourth surface portion 64. In this state, the wall plate part 113 extends parallel to the radial direction reference line including the disc axis similarly to the fourth surface portion 64.

Also, in the outer pad support part 101 of the first pad spring 24, the outer support plate part 112 of the guide recessed part 118 is disposed on the disc radial direction outer side in the guide recessed part 118. At that time, the outer support plate part 112 of the guide recessed part 118 faces the fifth surface portion 65 on the disc radial direction outer side in the engagement recessed part 75, and makes surface contact with the fifth surface portion 65. At this time, the outer support plate part 112 extends perpendicular to the radial direction reference line along the disc axis similarly to the fifth surface portion 65.

Also, in the outer pad support part 101 of the first pad spring 24, the extension plate part 114 of the guide recessed part 118 is disposed on the disc radial direction inner side in the guide recessed part 118. At that time, the extension plate part 114 of the guide recessed part 118 faces the third surface portion 63 on the disc radial direction inner side in the engagement recessed part 75. In this state, the extension plate part 114 extends parallel to the disc axial direction similarly to the third surface portion 63. However, in this state, the extension plate part 114 extends to be inclined with respect to the third surface portion 63 such that the wall plate part 113 side thereof in the disc rotation direction is closer to the third surface portion 63 in the disc radial direction than a side thereof opposite to the wall plate part 113 in the disc rotation direction is.

Also, in the outer pad support part 101 of the first pad spring 24, the engaging claw 119 of the guide recessed part 118 is disposed on the disc radial direction inner side in the guide recessed part 118. In this state, the engaging claw 119 protrudes from the extension plate part 114 to the disc rotation direction inner side and the disc radial direction inner side. In this state, the engaging claw 119 comes into contact with the third surface portion 63 of the engagement recessed part 75 and elastically deforms in the disc radial direction.

Also, in the outer pad support part 101 of the first pad spring 24, the inner plate part 115 extends to the disc radial direction inner side and the disc rotation direction inner side from the extension plate part 114.

Also, in the outer pad support part 101 of the first pad spring 24, the inner end plate part 116 extends from the inner plate part 115 to the disc radial direction inner side and the disc rotation direction outer side.

Also, in the outer pad support part 101 of the first pad spring 24, the outer end plate part 110 comes into contact with the corner portion 76 between the seventh surface portion 67 and the eighth surface portion 68 of the third connection part 51.

As described above, in the outer pad support part 101 of the first pad spring 24, the guide recessed part 118 fits into the engagement recessed part 75. At that time, the pad support part 101 comes into contact with the engagement recessed part 75 at the outer support plate part 112, the wall plate part 113, and the engaging claw 119.

In the outer pad support part 101 of the first pad spring 24, the outer support plate part 112 extends inward in the disc rotation direction from an end edge portion of the wall plate part 113 on the disc radial direction outer side, and the extension plate part 114 extends inward in the disc rotation direction from an end edge portion of the wall plate part 113 on the disc radial direction inner side. The outer support plate part 112, the wall plate part 113, and the extension plate part 114 all extend in the disc axial direction.

Also, in the outer pad support part 101 of the first pad spring 24, the curl plate part 122 of the spring plate part 120 is provided on a side of the extension plate part 114 opposite to the disc 11 in the disc axial direction. The curl plate part 122 extends from the extension plate part 114 to a side opposite to the disc 11, and then is folded back to the disc radial direction outer side. Then, the inner support plate part 123 of the spring plate part 120 extends from a distal end on the disc 11 side of the curl plate part 122 in the disc axial direction to approach the disc 11 in the disc axial direction.

In the first pad spring 24 in the attached state in which it is attached to the mounting member 20, the inner pad support part 101 shown in FIG. 2 engages with the engaging part 60 of the first connection part 46 in the same manner as the outer pad support part 101 engaging with the engaging part 60 of the third connection part 51.

As shown in FIG. 4, in an attached state in which the first pad spring 24 is attached to the mounting member 20, the base end side plate part 142 of the suppression part 102 extends to the disc radial direction outer side from an end edge portion of the pair of outer end plate parts 110 on a side opposite to the pair of outer plate parts 111. In this attached state, the base end side plate part 142 extends parallel to the tenth surface portion 70. Also, in this attached state, in the suppression part 102, the protruding plate part 151 and the contact plate part 152 protrude outward in the disc rotation direction from the base end side plate part 142, and come into contact with the tenth surface part 70 of the contact plate part 152.

Also, in this attached state, in the suppression part 102 of the first pad spring 24, the intermediate inclined plate part 143 extends to the disc radial direction outer side from the end edge portion of the base end side plate part 142 on a side opposite to the pair of outer end plate parts 110. In this attached state, the intermediate inclined plate part 143 is inclined with respect to the radial direction reference plane such that it becomes further away from the radial direction reference plane in the disc rotation direction toward the disc radial direction outer side.

Also, in this attached state, in the suppression part 102 of the first pad spring 24, the intermediate curved plate part 144 extends to the disc radial direction outer side from the end edge portion of the intermediate inclined plate part 143 on a side opposite to the base end side plate part 142. In this attached state, the intermediate curved plate part 144 is curved such that it extends from the intermediate inclined plate part 143 to the disc radial direction outer side and the disc rotation direction outer side, then extends to the disc radial direction outer side and the disc rotation direction inner side, and thereafter extends to the disc radial direction inner side and the disc rotation direction inner side. The axis of the center of curvature of the intermediate curved plate part 144 extends in the disc axial direction. In other words, the intermediate curved plate part 144 has a cylindrical shape extending in the disc axial direction.

Also, in this attached state, in the suppression part 102 of the first pad spring 24, the inclined plate part 145 extends to the disc radial direction inner side from the end edge portion of the intermediate curved plate part 144 on a side opposite to the end edge portion continuous with the intermediate inclined plate part 143. In this attached state, the inclined plate part 145 is inclined with respect to the radial direction reference plane so that it approaches the radial direction reference plane in the disc rotation direction toward the disc radial direction inner side.

Also, in this attached state, in the suppression part 102 of the first pad spring 24, the contact curved plate part 146 extends in the disc rotation direction inner side from the end edge portion of the inclined plate part 145 on a side opposite to the intermediate curved plate part 144. In this attached state, the contact curved plate part 146 is curved such that it extends from the inclined plate part 145 to the disc radial direction inner side and the disc rotation direction inner side, then extends to the disc radial direction outer side and the disc rotation direction inner side, and thereafter extends to the disc radial direction outer side and the disc rotation direction outer side. The axis of the center of curvature of the contact curved plate part 146 extends in the disc axial direction. In other words, the contact curved plate part 146 has a cylindrical shape extending in the disc axial direction.

The second pad spring 25 is also attached to the second connection part 47 and the fourth connection part 52, both of which are on the disc rotation direction second end side of the mounting member 20, similarly to the first pad spring 24.

As shown in FIG. 5, in the second pad spring 25 in an attached state in which it is attached to the mounting member 20, the outer pad support part 101 engages with the engaging part 60 of the fourth connection part 52. Also, in the second pad spring 25 in the attached state, the inner pad support part 101 shown in FIG. 1 engages with the engaging part 60 of the second connection part 47.

In this way, the first pad spring 24 and the second pad spring 25 are attached to the mounting member 20 to face each other in the disc rotation direction while they are separated from each other in the disc rotation direction.

The first friction pad 26 shown in FIG. 2 and the second friction pad 27 shown in FIG. 3 are engaged with the first pad spring 24 and second pad spring 25 attached to the mounting member 20. As shown in FIG. 1, the first friction pad 26 is supported by the first connection part 46 and the second connection part 47 of the mounting member 20 via the first pad spring 24 and the second pad spring 25. The second friction pad 27 is supported by the third connection part 51 and the fourth connection part 52 of the mounting member 20 via the first pad spring 24 and the second pad spring 25.

The inner first friction pad 26 and the outer second friction pad 27 are parts having substantially the same shape. The first friction pad 26 has a back plate 171 and a lining 172. Similarly, the second friction pad 27 has a back plate 171 and a lining 172 as shown in FIGS. 4 and 5. The lining 172 is attached to one surface side in a plate thickness direction of the back plate 171. Both the first friction pad 26 and the second friction pad 27 have their longitudinal directions aligned with a longitudinal direction of the back plate 171. As the first friction pad 26 shown in FIG. 1, both the first friction pad 26 and the second friction pad 27 are supported by the mounting member 20 via the first pad spring 24 and the second pad spring 25 with the lining 172 made to face the disc 11.

The back plate 171 has a mirror-symmetrical shape. The lining 172 also has a mirror-symmetrical shape. The first friction pad 26 and the second friction pad 27 have the same shape, and both have mirror-symmetrical shapes. The first friction pad 26 and the second friction pad 27 both have their longitudinal directions aligned with the disc rotation direction.

The inner first friction pad 26 and the outer second friction pad 27 are parts having substantially the same shape. Therefore, of these, the second friction pad 27 will be taken as an example and described with reference to FIGS. 4 and 5.

The back plate 171 has a main body part 175 and a pair of protruding parts 176. In the back plate 171, the pair of protruding parts 176 also have a mirror-symmetrical shape. The main body part 175 is provided at a center of the back plate 171 in the longitudinal direction. One of the protruding parts 176 is provided at one end portion of the back plate 171 in the longitudinal direction. The other of the protruding parts 176 is provided at the other end portion of the back plate 171 in the longitudinal direction. In other words, the pair of protruding parts 176 protrude in opposite directions from each other in the longitudinal direction from both end portions of the main body part 175 in the longitudinal direction of the back plate 171. The lining 172 is adhered to the main body part 175 of the back plate 171.

Since the second friction pad 27 has a mirror-symmetrical shape, a portion thereof on the disc rotation direction first end side will be mainly described on the basis of FIG. 4.

The protruding part 176 on the disc rotation direction first end side of the second friction pad 27 has an inner surface portion 181, an outer surface portion 182, a distal end surface portion 183, an inner chamfer 184, and an outer chamfer 185. The inner surface portion 181, the outer surface portion 182, the distal end surface portion 183, the inner chamfer 184, and the outer chamfer 185 all have a planar shape and all extend in a plate thickness direction of the back plate 171. Both the inner surface portion 181 and the outer surface portion 182 extend in the longitudinal direction of the back plate 171 from the main body part 175. The outer surface portion 182 is parallel to the inner surface portion 181 and faces in a direction opposite to the inner surface portion 181. The distal end surface portion 183 is an end portion on a side opposite to the main body part 175 in the longitudinal direction of the back plate 171. The distal end surface portion 183 extends perpendicular to the inner surface portion 181 and the outer surface portion 182. The inner chamfer 184 is continuous with the inner surface portion 181 and the distal end surface portion 183. The inner chamfer 184 approaches the outer surface portion 182 with distance away from the main body part 175 in the longitudinal direction of the back plate 171. The outer chamfer 185 approaches the inner surface portion 181 with distance away from the main body part 175 in the longitudinal direction of the back plate 171.

As shown in FIG. 5, the protruding part 176 on the disc rotation direction second end side of the second friction pad 27 has an inner surface portion 181, an outer surface portion 182, a distal end surface portion 183, an inner chamfer 184, and an outer chamfer 185 similarly to the protruding part 176 on the disc rotation direction first end side.

As shown in FIG. 4, the protruding part 176 on the disc rotation direction first end side of the second friction pad 27 is engaged with the outer pad support part 101 of the first pad spring 24 attached to the third connection part 51. As shown in FIG. 5, the protruding part 176 on the disc rotation direction second end side of the second friction pad 27 is engaged with the outer pad support part 101 of the second pad spring 25 attached to the fourth connection part 52. At that time, the second friction pad 27 has its longitudinal direction aligned with the disc rotation direction.

As shown in FIG. 1, the protruding part 176 on the disc rotation direction first end side of the first friction pad 26 is engaged with the inner pad support part 101 of the first pad spring 24 attached to the first connection part 46. The protruding part 176 on the disc rotation direction second end side of the first friction pad 26 is engaged with the inner pad support part 101 of the second pad spring 25 attached to the second connection part 47. At that time, the first friction pad 26 has its longitudinal direction aligned with the disc rotation direction.

In other words, the first pad spring 24 is provided on the mounting member 20 at one end side of the first friction pad 26 in the longitudinal direction and at one end side of the second friction pad 27 in the longitudinal direction. The second pad spring 25 is provided on the mounting member 20 at the other end side of the first friction pad 26 in the longitudinal direction and at the other end side of the second friction pad 27 in the longitudinal direction.

Here, an engagement state between the protruding part 176 on the disc rotation direction first end side of the first friction pad 26 and the first pad spring 24 is the same as an engagement state of the protruding part 176 on the disc rotation direction second end side of the first friction pad 26 and the second pad spring 25. Also, an engagement state between the protruding part 176 on the disc rotation direction first end side of the second friction pad 27 and the first pad spring 24 is the same as an engagement state between the protruding part 176 on the disc rotation direction second end side of the second friction pad 27 and the second pad spring 25. Moreover, the engagement states of these four positions are the same. Therefore, here, the engagement state between the protruding part 176 on the disc rotation direction first end side of the second friction pad 27 and the outer pad support part 101 of the first pad spring 24 will be mainly described on the basis of FIG. 4.

The protruding part 176 on the disc rotation direction first end side of the second friction pad 27 is inserted into the guide recessed part 118 by elastically deforming the inner support plate part 123 of the outer spring plate part 120 of the first pad spring 24 to bring it closer to the extension plate part 114. Thereby, the protruding part 176 is inserted into the engagement recessed part 75 of the third connection part 51 on the disc rotation direction first end side of the mounting member 20 to support the third connection part 51. In this state, the inner surface portion 181 of the protruding part 176 on the disc radial direction inner side comes into contact with the inner support plate part 123 of the spring plate part 120. Also, in this state, the protruding part 176 of the second friction pad 27 is pressed outward in the disc radial direction by an urging force of the spring plate part 120. In the second friction pad 27 urged outward in the disc radial direction in this way, in a state in which there is no input from the disc 11, the protruding part 176 on the disc rotation direction first end side is pressed against the outer support plate part 112 of the outer guide recessed part 118 of the first pad spring 24 on the disc rotation direction first end side to be in surface contact therewith at the outer surface portion 182. Also, in this state, the distal end surface portion 183 at an outer end of the protruding part 176 in the disc rotation direction faces the wall plate part 113. Also, in this state, the protruding part 176 on the disc rotation direction first end side of the second friction pad 27 is supported by the outer guide recessed part 118 of the first pad spring 24 to be movable in the disc axial direction. In other words, the outer pad support part 101 of the first pad spring 24 supports a portion of the second friction pad 27 on the disc rotation direction first end side. In yet other words, the protruding part 176 on the disc rotation direction first end side of the second friction pad 27 is supported by the engagement recessed part 75 of the third connection part 51 via the outer pad support part 101 of the first pad spring 24 to be movable in the disc axial direction. An end portion of the main body part 175 on the disc rotation direction first end side of the second friction pad 27 comes into contact with a boundary portion between the inner plate part 115 and the inner end plate part 116.

As described above, the second friction pad 27 supported by the third connection part 51 in one protruding part 176 is supported by the fourth connection part 52 with the other protruding part 176 engaging with the engagement recessed part 75 via the outer guide recessed part 118 of the second pad spring 25 on the disc rotation direction second end side as shown in FIG. 5. In this state, the protruding part 176 on the disc rotation direction second end side engages with the second pad spring 25 in the same manner as the engagement state between the first pad spring 24 and the protruding part 176 on the disc rotation direction first end side. Thereby, the protruding part 176 on the disc rotation direction second end side of the second friction pad 27 is supported by the fourth connection part 52 via the outer pad support part 101 of the second pad spring 25 to be movable in the disc axial direction. Therefore, the outer second friction pad 27 is movably provided on the mounting member 20 including the third connection part 51 and the fourth connection part 52. The first pad spring 24 and the second pad spring 25 guide sliding of the second friction pad 27 in the disc axial direction, and urge the second friction pad 27 outward in the disc radial direction.

Similarly, also for the inner first friction pad 26, the protruding part 176 on the disc rotation direction first end side shown in FIG. 1 is supported by the first connection part 46 via the inner pad support part 101 of the first pad spring 24. At the same time, the protruding part 176 on the disc rotation direction second end side of the inner first friction pad 26 is supported by the second connection part 47 via the inner pad support part 101 of the second pad spring 25. The first friction pad 26 is supported by the first connection part 46 and the second connection part 47 via the first pad spring 24 and the second pad spring 25 to be movable in the disc axial direction. Therefore, the first friction pad 26 is movably provided on the mounting member 20 including the first connection part 46 and the second connection part 47. The first pad spring 24 and the second pad spring 25 guide sliding of the first friction pad 26 in the disc axial direction, and urge the first friction pad 26 outward in the disc radial direction.

Both the first friction pad 26 and the second friction pad 27 come into contact with the disc 11 on a surface of the lining 172 on a side opposite to the back plate 171. That is, the outer second friction pad 27 is in a state in which the lining 172 shown in FIGS. 4 and 5 is made to face the second braking surface 11b on the outer side of the disc 11 shown in FIG. 1. The inner first friction pad 26 is in a state in which the lining 172 is made to face the first braking surface 11a on the inner side of the disc 11.

The caliper 21 includes a caliper main body 201, a first slide pin 202, a second slide pin 203, a mounting bolt 204, a mounting bolt 205, and a piston 206.

The caliper 21 has a substantially mirror-symmetrical shape, and the radial direction reference line and the radial direction reference plane pass through a center position of the caliper 21 in the disc rotation direction. In the caliper 21, the first slide pin 202 is fixed to the caliper main body 201 with the mounting bolt 204. Also, in the caliper 21, the second slide pin 203 is fixed to the caliper main body 201 with the mounting bolt 205. This pair of the first slide pin 202 and the second slide pin 203 are aligned in position in the axial direction and are disposed parallel to each other. In the caliper 21, the first slide pin 202 is slidably fitted into the first pin insertion hole 48 formed in the first coupling part 33 of the mounting member 20 as shown in FIG. 4. Also, in the caliper 21, the second slide pin 203 shown in FIG. 1 is slidably fitted into the second pin insertion hole 49 formed in the second coupling part 34 of the mounting member 20 as shown in FIG. 5. As shown in FIG. 1, the caliper 21 includes the pair of the first slide pin 202 and the second slide pin 203 disposed on both sides in the disc rotation direction.

In the caliper 21, the caliper main body 201 is supported by the mounting member 20 via the first slide pin 202 and the second slide pin 203 to be slidable in the disc axial direction. In other words, the mounting member 20 supports the caliper 21 to be slidable in the disc axial direction at the pair of the first coupling part 33 and the second coupling part 34. Therefore, the caliper 21 is provided on the mounting member 20 to be movable in the disc axial direction. The first pin boot 22 covers a portion of the first slide pin 202 protruding from the mounting member 20. The second pin boot 23 covers a portion of the second slide pin 203 protruding from the mounting member 20.

The caliper main body 201 has a substantially mirror-symmetrical shape. The radial direction reference line and the radial direction reference plane pass through a center position of the caliper main body 201 in the disc rotation direction. The caliper main body 201 includes a cylinder part 221, a bridge part 222, a claw part 223 shown in FIG. 3, a first pin disposition part 224, and a second pin disposition part 225.

As shown in FIG. 2, the cylinder part 221 is disposed on the inner side of the disc 11 in the disc axial direction. The bridge part 222 extends outward in the disc axial direction to straddle a circumference of the disc 11 from a portion of the cylinder part 221 on the disc radial direction outer side. As shown in FIG. 3, the claw part 223 extends to the disc radial direction inner side from a portion of the bridge part 222 on a side opposite to the cylinder part 221 and is disposed on the outer side of the disc 11. The first pin disposition part 224 is disposed on the disc rotation direction first end side with respect to the cylinder part 221. The second pin disposition part 225 is disposed on the disc rotation direction second end side with respect to the cylinder part 221. The first slide pin 202 is fixed to the first pin disposition part 224 of the caliper main body 201 with the mounting bolt 204. The second slide pin 203 is fixed to the second pin disposition part 225 of the caliper main body 201 with the mounting bolt 205.

As shown in FIG. 1, the cylinder part 221 has a cylinder hole 231. The cylinder hole 231 is recessed from an end surface of the cylinder part 221 on the disc 11 side in a direction opposite to the disc 11. Therefore, the cylinder hole 231 opens to the disc 11 side. The cylinder hole 231 extends in the disc axial direction. The piston 206 is accommodated in the cylinder hole 231 of the cylinder part 221. The claw part 223 shown in FIG. 3 is provided to face the cylinder part 221 in an axial direction of the cylinder hole 231 from the bridge part 222.

The bridge part 222 includes an inner circumferential part 251, an outer circumferential part 252, a first lateral part 253 (lateral part), and a first inclined part 254 (inclined part) shown in FIG. 4, and a second lateral part 255 (lateral part) and a second inclined part 256 (inclined part) shown in FIG. 5.

The inner circumferential part 251 forms an end portion of the bridge part 222 on the disc radial direction inner side. Therefore, the inner circumferential part 251 faces a side of the first friction pad 26, second friction pad 27, and disc 11.

The inner circumferential part 251 has an inner circumferential surface 251a facing the disc radial direction inner side. The inner circumferential surface 251a extends in the disc axial direction and has a shape of a part of a substantially cylindrical surface. The cylindrical surface is a cylindrical surface with a central axis of the disc 11 as a center. The inner circumferential part 251, including the inner circumferential surface 251a, has a mirror-symmetrical shape with respect to the radial direction reference plane.

The outer circumferential part 252 forms an end portion of the bridge part 222 on the disc radial direction outer side. Therefore, the outer circumferential part 252 is on a side opposite to the inner circumferential part 251 in the bridge part 222.

The outer circumferential part 252 has an outer circumferential surface 252a facing the disc radial direction outer side. The outer circumferential surface 252a extends substantially in the disc axial direction and has a shape of a part of a substantially cylindrical surface. The cylindrical surface is a cylindrical surface with a central axis of the disc 11 as a center. The outer circumferential part 252, including the outer circumferential surface 252a, has a mirror-symmetrical shape with respect to the radial direction reference plane.

The first lateral part 253 shown in FIG. 4 forms an end portion of the bridge part 222 on the disc rotation direction outer side. The first lateral part 253 specifically forms an end portion of the bridge part 222 on the disc rotation direction first end side. The first lateral part 253 is continuous with an end portion of the outer circumferential part 252 on the disc rotation direction first end side and extends in the disc axial direction.

The first lateral part 253 has a first lateral surface 253a facing the disc rotation direction outer side. The first lateral surface 253a faces the disc rotation direction first end side. The first lateral surface 253a has a planar shape and extends in the disc axial direction. The first lateral surface 253a extends parallel to the radial direction reference plane. The first lateral surface 253a is continuous with an end edge portion of the outer circumferential surface 252a on the disc rotation direction first end side.

The first inclined part 254 forms an end portion of the bridge part 222 on the disc rotation direction outer side and an end portion thereof on the disc radial direction inner side. Specifically, the first inclined part 254 forms an end portion of the bridge part 222 on the disc rotation direction first end side and an end portion thereof on the disc radial direction inner side. The first inclined part 254 connects an end portion of the inner circumferential part 251 on the disc rotation direction first end side and an end portion of the first lateral part 253 on the disc radial direction inner side in the bridge part 222. The first inclined part 254 is continuous with the first lateral part 253 and the inner circumferential part 251, and extends in the disc axial direction. The first inclined part 254 is inclined toward the inner circumferential part 251 with respect to the first lateral part 253 when viewed from the disc axial direction.

The first inclined part 254 has a first inclined surface 254a facing the disc rotation direction outer side and the disc radial direction inner side. Specifically, the first inclined surface 254a faces the disc rotation direction first end side and the disc radial direction inner side. The first inclined surface 254a has a planar shape and extends in the disc axial direction. The first inclined surface 254a is continuous with the first lateral surface 253a and the inner circumferential surface 251a. The first inclined surface 254a extends to be inclined with respect to the radial direction reference plane. The first inclined surface 254a is inclined with respect to the radial direction reference plane so that it approaches the radial direction reference plane toward the disc radial direction inner side.

The second lateral part 255 shown in FIG. 5 forms an end portion of the bridge part 222 on the disc rotation direction outer side. The second lateral part 255 specifically forms an end portion of the bridge part 222 on the disc rotation direction second end side. The second lateral part 255 is continuous with an end portion of the outer circumferential part 252 on the disc rotation direction second end side and extends in the axial direction of the disc 11.

The second lateral part 255 has a second lateral surface 255a facing the disc rotation direction outer side. The second lateral surface 255a faces the disc rotation direction second end side. The second lateral surface 255a has a planar shape and extends in the disc axial direction. The second lateral surface 255a extends parallel to the radial direction reference plane. The second lateral surface 255a is continuous with an end edge portion of the outer circumferential surface 252a on the disc rotation direction second end side. The second lateral surface 255a faces in a direction opposite to the first lateral surface 253a shown in FIG. 4. The second lateral surface 255a shown in FIG. 5 extends parallel to the first lateral surface 253a shown in FIG. 4. The second lateral surface 255a and the first lateral surface 253a have a mirror-symmetrical shape. The second lateral part 255 and the first lateral part 253 253a have a mirror-symmetrical shape.

The second inclined part 256 shown in FIG. 5 forms an end portion of the bridge part 222 on the disc rotation direction outer side and an end portion thereof on the disc radial direction inner side. The second inclined part 256 specifically forms an end portion of the bridge part 222 on the disc rotation direction second end side and an end portion thereof on the disc radial direction inner side. The second inclined part 256 connects an end portion of the inner circumferential part 251 on the disc rotation direction second end side and an end portion of the second lateral part 255 on the disc radial direction inner side in the bridge part 222. The second inclined part 256 is continuous with the second lateral part 255 and the inner circumferential part 251 and extends in the disc axial direction. The second inclined part 256 is inclined toward the inner circumferential part 251 with respect to the second lateral part 255 when viewed from the disc axial direction.

The second inclined part 256 has a second inclined surface 256a facing the disc rotation direction outer side and the disc radial direction inner side. Specifically, the second inclined surface 256a faces the disc rotation direction second end side and the disc radial direction inner side. The second inclined surface 256a has a planar shape and extends in the disc axial direction. The second inclined surface 256a is continuous with the second lateral surface 255a and the inner circumferential surface 251a. The second inclined surface 256a extends to be inclined with respect to the radial direction reference plane. The second inclined surface 256a is inclined with respect to the radial direction reference plane so that it approaches the radial direction reference plane toward the disc radial direction inner side. The second inclined surface 256a shown in FIG. 5 and the first inclined surface 254a shown in FIG. 4 have a mirror-symmetrical shape. The second inclined part 256 and the first inclined part 254 have a mirror-symmetrical shape.

As described above, the first pad spring 24 shown in FIG. 4 is attached to the mounting member 20. Also, as described above, the caliper 21 is supported by the mounting member 20 to be movable in the disc axial direction. Also, the suppression part 102 of the first pad spring 24 is in contact with the caliper 21. Specifically, in the suppression part 102 of the first pad spring 24, the contact curved plate part 146 thereof is in contact with the first inclined surface 254a of the first inclined part 254 of the bridge part 222. At that time, in the suppression part 102 of the first pad spring 24, mainly the intermediate curved plate part 144 deforms elastically to bring the inclined plate part 145 and the contact curved plate part 146 closer to the base end side plate part 142 and the intermediate inclined plate part 143. Then, the suppression part 102 of the first pad spring 24 presses the bridge part 222 in a direction perpendicular to the first inclined surface 254a. That is, the suppression part 102 of the first pad spring 24 presses the caliper 21 toward both the disc rotation direction inner side and the disc radial direction outer side. In other words, the suppression part 102 of the first pad spring 24 suppresses movement of the caliper 21 toward the disc rotation direction outer side and movement thereof toward the disc radial direction inner side. Specifically, in the suppression part 102 of the first pad spring 24, mainly the intermediate curved plate part 144, the inclined plate part 145, and the contact curved plate part 146 press the caliper 21 toward both the disc rotation direction second end side and the disc radial direction outer side. In other words, in the suppression part 102 of the first pad spring 24, mainly the intermediate curved plate part 144, the inclined plate part 145, and the contact curved plate part 146 suppress movement of the caliper 21 toward the disc rotation direction first end side and movement thereof toward the disc radial direction inner side. Here, the contact curved plate part 146 of the first pad spring 24 has a cylindrical shape extending in the disc axial direction. Also, the first inclined surface 254a of the bridge part 222 has a planar shape extending in the disc axial direction. Therefore, the contact curved plate part 146 of the first pad spring 24 and the first inclined surface 254a are in line contact with each other. This contact line extends in the disc axial direction.

As shown in FIG. 5, the suppression part 102 of the second pad spring 25 also is in contact with the caliper 21. Specifically, in the suppression part 102 of the second pad spring 25, the contact curved plate part 146 thereof comes into contact with the second inclined surface 256a of the second inclined part 256 of the bridge part 222. At that time, in the suppression part 102 of the second pad spring 25, mainly the intermediate curved plate part 144 deforms elastically to bring the inclined plate part 145 and the contact curved plate part 146 closer to the base end side plate part 142 and the intermediate inclined plate part 143. Then, the suppression part 102 of the second pad spring 25 presses the bridge part 222 in a direction perpendicular to the second inclined surface 256a. That is, the suppression part 102 of the second pad spring 25 presses the caliper 21 toward both the disc rotation direction inner side and the disc radial direction outer side. In other words, the suppression part 102 of the second pad spring 25 suppresses movement of the caliper 21 toward the disc rotation direction outer side and movement thereof toward the disc radial direction inner side. Specifically, in the suppression part 102 of the second pad spring 25, mainly the intermediate curved plate part 144, the inclined plate part 145, and the contact curved plate part 146 press the caliper 21 toward both the disc rotation direction first end side and the disc radial direction outer side. In other words, in the suppression part 102 of the second pad spring 25, mainly the intermediate curved plate part 144, the inclined plate part 145, and the contact curved plate part 146 suppress movement of the caliper 21 toward the disc rotation direction second end side and movement thereof toward the disc radial direction inner side. Here, the contact curved plate part 146 of the second pad spring 25 has a cylindrical shape extending in the disc axial direction. Also, the second inclined surface 256a of the bridge part 222 has a planar shape extending in the disc axial direction. Therefore, the contact curved plate part 146 of the second pad spring 25 and the second inclined surface 256a are in line contact with each other. This contact line extends in the disc axial direction.

As described above, the suppression part 102 of the first pad spring 24, which is one of the pair of the first pad spring 24 and the second pad spring 25, suppresses both the movement of the caliper 21 in the disc rotation direction and the movement of the caliper 21 in the disc radial direction. Also, the suppression part 102 of the second pad spring 25, which is the other of the pair of the first pad spring 24 and the second pad spring 25, suppresses both the movement of the caliper 21 in the disc rotation direction and the movement of the caliper 21 in the disc radial direction.

The piston 206 shown in FIG. 1 is accommodated in the cylinder hole 231 of the cylinder part 221 to be movable in the disc axial direction. Therefore, the caliper 21 accommodates the piston 206 in the cylinder hole 231 to move in the axial direction of the disc 11. The piston 206 faces the first braking surface 11a of the disc 11. The first friction pad 26 is disposed between the first braking surface 11a of the disc 11 and the piston 206. When the piston 206 moves forward toward the first braking surface 11a of the disc 11, it presses the first friction pad 26.

A brake fluid is introduced into the disc brake 10 between the cylinder hole 231 of the cylinder part 221 and the piston 206 of the caliper 21 via a brake pipe (not shown). Then, in the caliper 21, a brake hydraulic pressure acts on the piston 206 in the cylinder part 221, and the piston 206 moves forward to the disc 11 side. The piston 206 moving forward in this way comes into contact with the inner first friction pad 26 disposed between the piston 206 and the disc 11 and presses the inner first friction pad 26 toward the disc 11. Then, the inner first friction pad 26 is guided by the mounting member 20 via the first pad spring 24 and the second pad spring 25 to move in the disc axial direction and comes into contact with the first braking surface 11a on one side of the disc 11 at the lining 172.

Due to a reaction force of this pressing, the caliper main body 201 slides the first slide pin 202 and the second slide pin 203 with respect to the mounting member 20, and thereby the caliper 21 moves in the disc axial direction. Here, the contact curved plate part 146 of the first pad spring 24 shown in FIG. 4 has a cylindrical shape extending in the disc axial direction, and the first inclined surface 254a of the caliper main body 201 has a planar shape extending in the disc axial direction. Therefore, when the caliper main body 201 moves in the disc axial direction with respect to the mounting member 20, the first inclined surface 254a of the caliper main body 201 slides on the contact curved plate part 146 of the first pad spring 24 in the disc axial direction. Also, the contact curved plate part 146 of the second pad spring 25 shown in FIG. 5 has a cylindrical shape extending in the disc axial direction, and the second inclined surface 256a of the caliper main body 201 has a planar shape extending in the disc axial direction. Therefore, when the caliper main body 201 moves in the disc axial direction with respect to the mounting member 20, the second inclined surface 256a of the caliper main body 201 slides on the contact curved plate part 146 of the second pad spring 25 in the disc axial direction.

When the caliper main body 201 moves in the disc axial direction with respect to the mounting member 20 due to the reaction force of the pressing of the piston 206 as described above, the claw part 223 of the caliper main body 201 comes into contact with the outer second friction pad 27 disposed between the claw part 223 and the disc 11. Then, the claw part 223 presses the second friction pad 27 toward the disc 11. Then, the outer second friction pad 27 is guided by the mounting member 20 via the first pad spring 24 and the second pad spring 25 to move in the disc axial direction and comes into contact with the second braking surface 11b on the other side of the disc 11 at the lining 172.

In this way, the caliper 21 slidably supported by the mounting member 20 sandwiches the pair of the first friction pad 26 and the second friction pad 27 with the piston 206 and the claw part 223 from both sides in the disc axial direction due to an operation of the piston 206. Also, the caliper 21 presses the first friction pad 26 and the second friction pad 27 against both surfaces of the first braking surface 11a and the second braking surface 11b of the disc 11. In other words, the pair of the first friction pad 26 and the second friction pad 27 are pressed against both surfaces of the first braking surface 11a and the second braking surface 11b of the disc 11 by the caliper 21. As a result, the disc brake 10 applies frictional resistance to the disc 11 to generate a braking force. At that time, it is assumed that the disc 11 rotates to move from the disc rotation direction second end side to the disc rotation direction first end side in the disc brake 10. In this case, the first connection part 46 on the disc rotation direction first end side of the mounting member 20 mainly receives a braking torque from the first friction pad 26. Also, in this case, the third connection part 51 on the disc rotation direction first end side of the mounting member 20 mainly receives a braking torque from the second friction pad 27. Also, it is assumed that the disc 11 rotates to move from the disc rotation direction first end side to the disc rotation direction second end side in the disc brake 10. In this case, the second connection part 47 on the disc rotation direction second end side of the mounting member 20 mainly receives a braking torque from the first friction pad 26. Also, in this case, the fourth connection part 52 on the disc rotation direction second end side mainly receives a braking torque from the second friction pad 27. The caliper 21 is a so-called fist type (slide type) caliper.

The above-described Patent Document 1 discloses a technology in which rattling of a caliper body when a vehicle travels or brakes is suppressed by elastically supporting a reaction claw of the caliper body with a retainer. However, in the disc brake described in Patent Document 1, the retainer is attached to a tie bar of a caliper bracket, and the tie bar elastically supports a center of the reaction claw of the caliper body. Therefore, a load applied to the retainer increases, and there has been a likelihood that durability of the retainer will decrease. That is, in the caliper body, a center position of the reaction claw is a portion in which a length in a disc axial direction is small. Therefore, a length of the retainer in the disc axial direction also becomes small. As a result, a load applied to the retainer increases, and there has been a likelihood that durability of the retainer will decrease.

In the disc brake 10 of the first embodiment, the pair of the first pad spring 24 and the second pad spring 25 provided on the mounting member 20 have the suppression parts 102 that suppress both movement of the caliper 21 in the disc rotation direction and movement of the caliper 21 in the disc radial direction. Here, movement of the caliper 21 in a direction other than the disc axial direction and an inclination thereof with respect to the disc axial direction may cause dragging of the first friction pad 26 and the second friction pad 27. Also, movement of the caliper 21 in a direction other than the disc axial direction and an inclination thereof with respect to the disc axial direction may cause uneven wear on the first friction pad 26 and the second friction pad 27. In the disc brake 10 of the first embodiment, movement of the caliper 21 in a direction other than the disc axial direction and an inclination thereof with respect to the disc axial direction can be suppressed by the suppression parts 102. Therefore, dragging of the first friction pad 26 and the second friction pad 27 can be suppressed, and uneven wear of the first friction pad 26 and the second friction pad 27 can be suppressed. Therefore, a decrease in a fuel consumption rate of the vehicle due to dragging of the first friction pad 26 and the second friction pad 27 can be suppressed, and generation of abnormal noise due to uneven wear of the first friction pad 26 and the second friction pad 27 can be suppressed.

As described above, in the disc brake 10, the suppression part 102 suppresses both the movement of the caliper 21 in the disc rotation direction and the movement of the caliper 21 in the disc radial direction. Therefore, movement of the caliper 21 in a direction other than the disc axial direction and an inclination thereof with respect to the disc axial direction can be further suppressed. Therefore, dragging of the first friction pad 26 and the second friction pad 27 can be further suppressed, and uneven wear of the first friction pad 26 and the second friction pad 27 can be further suppressed.

As described above, the disc brake 10 suppresses both the movement of the caliper 21 in the disc rotation direction and the movement of the caliper 21 in the disc radial direction by both the suppression part 102 of the first pad spring 24 and the suppression part 102 of the second pad spring 25. Therefore, movement of the caliper 21 in a direction other than the disc axial direction and an inclination thereof with respect to the disc axial direction can be further suppressed. Therefore, dragging of the first friction pad 26 and the second friction pad 27 can be further suppressed, and uneven wear of the first friction pad 26 and the second friction pad 27 can be further suppressed.

As described above, the disc brake 10 suppresses movement of the caliper 21 in a direction other than the disc axial direction by the first pad spring 24 and the second pad spring 25. The first pad spring 24 is a member attached to the mounting member 20 at one end side of the first friction pad 26 and second friction pad 27 in the longitudinal direction. The second pad spring 25 is a member attached to the mounting member 20 at the other end side of the first friction pad 26 and the second friction pad 27 in the longitudinal direction. In this way, the disc brake 10 includes the suppression parts 102 provided in the first pad spring 24 and the second pad spring 25 which are members attached to the mounting member 20 on the end portion sides in the longitudinal direction of the first friction pad 26 and the second friction pad 27. Therefore, the suppression part 102 can be disposed in a portion of the caliper 21 in which a length in the disc axial direction can be relatively secured. Therefore, a length of the suppression part 102 in the disc axial direction can be secured. Therefore, it is possible to suppress a decrease in durability of the first pad spring 24 and the second pad spring 25 including the suppression parts 102, and furthermore, a decrease in durability of the disc brake 10.

The disc brake 10 includes the suppression parts 102 provided in the first pad spring 24 and the second pad spring 25 each having the pad support parts 101 that support the first friction pad 26 and the second friction pad 27. Therefore, the number of parts can be reduced compared to a case in which a member for suppressing movement of the caliper 21 in a direction other than the disc axial direction is provided in addition to the pad springs that support the first friction pad 26 and the second friction pad 27. Therefore, parts costs and assembly costs can be reduced.

The disc brake 10 includes the suppression parts 102 provided in both the first pad spring 24 and the second pad spring 25. Therefore, a load that each of the suppression part 102 of the first pad spring 24 and the suppression part 102 of the second pad spring 25 is responsible for can be suppressed. Therefore, it is possible to further suppress a decrease in durability of the first pad spring 24 including the suppression part 102 and the second pad spring 25 including the suppression part 102, and furthermore, a decrease in durability of the disc brake 10.

In the disc brake 10, the suppression part 102 of the first pad spring 24 is in contact with the first inclined part 254 of the bridge part 222 of the caliper 21. The first inclined part 254 extends in the disc axial direction to be continuous with the first lateral part 253 and the inner circumferential part 251, and is inclined toward the inner circumferential part 251 side with respect to the first lateral part 253 when viewed from the disc axial direction. Thereby, suppression of movement of the caliper 21 outward in the disc rotation direction and inward in the disc radial direction by the suppression part 102 of the first pad spring 24 can be realized with a simple structure. Similarly, the suppression part 102 of the second pad spring 25 is in contact with the second inclined part 256 of the bridge part 222 of the caliper 21. The second inclined part 256 extends in the disc axial direction while being continuous with the second lateral part 255 and the inner circumferential part 251, and is inclined toward the inner circumferential part 251 side with respect to the second lateral part 255 when viewed from the disc axial direction. Thereby, suppression of movement of the caliper 21 outward in the disc rotation direction and inward in the disc radial direction by the suppression part 102 of the second pad spring 25 can be realized with a simple structure.

As described above, in the disc brake 10 of the first embodiment, both the movement of the caliper 21 in the disc rotation direction and the movement of the caliper 21 in the disc radial direction are suppressed by both the suppression part 102 of the first pad spring 24 and the suppression part 102 of the second pad spring 25. Alternatively, the suppression part 102 may be provided in only one of the first pad spring 24 and the second pad spring 25. That is, the suppression part 102 may be provided in at least one of the pair of the first pad spring 24 and the second pad spring 25. Also, only one of the movement of the caliper 21 in the disc rotation direction and the movement of the caliper 21 in the disc radial direction may be suppressed by the suppression part 102. That is, at least one of the movement of the caliper 21 in the disc rotation direction and the movement of the caliper 21 in the disc radial direction need only be suppressed by the suppression part 102.

Also, in the disc brake 10 of the first embodiment, the suppression part 102 is provided in the first pad spring 24, and the suppression part 102 is provided in the second pad spring 25. Alternatively, a suppression part suppressing movement of the caliper 21 in a direction other than the disc axial direction may be provided separately from the first pad spring 24, and a suppression part suppressing movement of the caliper 21 in a direction other than the disc axial direction may be provided separately from the second pad spring 25. In that case, one of the suppression parts is provided on the mounting member 20 at one end side of the first friction pad 26 and the second friction pad 27 in the longitudinal direction. Also, the other of the suppression parts is provided on the mounting member 20 at the other end side of the first friction pad 26 and the second friction pad 27 in the longitudinal direction.

### Second Embodiment

A second embodiment will be described mainly on the basis of FIG. 7, focusing on the differences from the first embodiment. Further, parts common to those in the first embodiment will be denoted by the same terms and the same reference signs.

As shown in FIG. 7, instead of the first pad spring 24 of the first embodiment, a disc brake 10A of the second embodiment includes a first pad spring 24A (a pad spring, for example, a first pad spring, or for example, a first suppression member) that is partially different from the first pad spring 24 of the first embodiment. Also, although not shown in the drawings, instead of the second pad spring 25 of the first embodiment, the disc brake 10A includes a second pad spring (a pad spring, for example, a second pad spring, or for example, a second suppression member) that is similar to the first pad spring 24A.

In the disc brake 10A, the first pad spring 24A and the second pad spring (not shown) are common parts having the same shape. Therefore, description will be made mainly by taking the first pad spring 24A as an example.

The first pad spring 24A also has a mirror-symmetrical shape similarly to the first pad spring 24. The first pad spring 24A is also formed by press-forming a single sheet of a metal plate material having a constant thickness similarly to the first pad spring 24. The first pad spring 24A includes a pair of pad support parts 101 that are similar to those of the first embodiment, and a suppression part 102A that is partially different from the suppression part 102 of the first embodiment.

The suppression part 102A includes a base end side plate part 142, an intermediate inclined plate part 143, an intermediate curved plate part 144, an inclined plate part 145, a protruding plate part 151, a contact plate part 152, and an opening 153, all of which are similar to those in the suppression part 102. The suppression part 102A has a contact curved plate part 146A that is slightly different from the contact curved plate part 146, and a distal end side plate part 271A and a distal end side curved plate part 272A, both of which are not in the suppression part 102.

The contact curved plate part 146A has a curved shape to form a cylindrical shape. The contact curved plate part 146A extends from an end edge portion of the inclined plate part 145 on a side opposite to the intermediate curved plate part 144. The contact curved plate part 146A extends to a side opposite to the intermediate curved plate part 144 in a thickness direction of the inclined plate part 145 while being separated from the intermediate curved plate part 144 in a thickness direction of an outer support plate part 112. Thereafter, the contact curved plate part 146A extends such that it becomes further away from the intermediate curved plate part 144 in the thickness direction of the inclined plate part 145 while approaching the intermediate curved plate part 144 in the thickness direction of the outer support plate part 112. Thereafter, the contact curved plate part 146A extends such that it approaches the intermediate curved plate part 144 in the thickness direction of the inclined plate part 145 while approaching the intermediate curved plate part 144 in the thickness direction of the outer support plate part 112. Thereafter, the contact curved plate part 146A extends in a substantially flat plate shape to approach the intermediate curved plate part 144 in the thickness direction of the inclined plate part 145.

The distal end side plate part 271A extends from an end edge portion of the contact curved plate part 146A on a side opposite to an end edge portion continuous with the inclined plate part 145. The distal end side plate part 271A extends in a direction away from the outer support plate part 112 from the contact curved plate part 146A in the thickness direction of the outer support plate part 112. The distal end side plate part 271A extends from the contact curved plate part 146A so that it extends substantially parallel to the inclined plate part 145.

The distal end side curved plate part 272A has a curved shape to form a cylindrical shape. The distal end side curved plate part 272A extends from an end edge portion of the distal end side plate part 271A on a side opposite to the contact curved plate part 146A. The distal end side curved plate part 272A extends from the distal end side plate part 271A such that it becomes further away from the inclined plate part 145 in a thickness direction of the distal end side plate part 271A while being separated from the outer support plate part 112 in the thickness direction of the outer support plate part 112. Thereafter, the distal end side curved plate part 272A extends such that it becomes further away from the inclined plate part 145 in the thickness direction of the distal end side plate part 271A while approaching the outer support plate part 112 in the thickness direction of the outer support plate part 112. Thereafter, the distal end side curved plate part 272A extends such that it approaches the inclined plate part 145 in the thickness direction of the distal end side plate part 271A while approaching the outer support plate part 112 in the thickness direction of the outer support plate part 112.

A boundary line between the intermediate curved plate part 144 and the inclined plate part 145, a boundary line between the inclined plate part 145 and the contact curved plate part 146A, a boundary line between the contact curved plate part 146A and the distal end side plate part 271A, and a boundary line between the distal end side plate part 271A and the distal end side curved plate part 272A are parallel to each other. These boundary lines are parallel to an axis of a center of curvature of the cylindrical portion of the contact curved plate part 146A. These boundary lines are parallel to an axis of a center of curvature of the distal end side plate part 271A.

The first pad spring 24A is attached to a mounting member 20 in the same manner as the first pad spring 24. At that time, the first pad spring 24 is in a state in which the suppression part 102A is disposed on a disc radial direction outer side with respect to the pad support part 101. Also, at that time, the first pad spring 24A is positioned in a disc radial direction, a disc rotation direction, and a disc axial direction with respect to the mounting member 20.

In an attached state in which the first pad spring 24A is attached to the mounting member 20, the contact curved plate part 146A of the suppression part 102A extends from an end edge portion of the inclined plate part 145 on the disc radial direction inner side. In this attached state, the contact curved plate part 146A is curved such that it extends from the inclined plate part 145 to the disc radial direction inner side and a disc rotation direction inner side, then extends to the disc radial direction outer side and the disc rotation direction inner side, and thereafter extends to the disc radial direction outer side and a disc rotation direction outer side. Thereafter, the contact curved plate part 146A extends in a substantially flat plate shape to the disc rotation direction outer side. An axis of the center of curvature of the cylindrical portion of the contact curved plate part 146A extends in the disc axial direction. In other words, the contact curved plate part 146A has a cylindrical portion extending in the disc axial direction.

Also, in this attached state, in the suppression part 102A of the first pad spring 24A, the distal end side plate part 271A extends to the disc radial direction outer side from the end edge portion of the contact curved plate part 146A on a side opposite to an end edge portion continuous with the inclined plate part 145. In this attached state, the distal end side plate part 271A is inclined with respect to a radial direction reference plane such that it becomes further away from the radial direction reference plane in the disc rotation direction toward the disc radial direction outer side.

In addition, in this attached state, in the suppression part 102A of the first pad spring 24A, the distal end side curved plate part 272A extends from the end edge portion of the distal end side plate part 271A on a side opposite to the contact curved plate part 146A. In this attached state, the distal end side curved plate part 272A is curved such that it extends from the distal end side plate part 271A to the disc radial direction outer side and the disc rotation direction inner side, then extends to the disc radial direction inner side and the disc rotation direction inner side, and thereafter extends to the disc radial direction inner side and the disc rotation direction outer side. An axis of a center of curvature of the distal end side curved plate part 272A extends in the disc axial direction. In other words, the distal end side curved plate part 272A has a cylindrical shape extending in the disc axial direction.

The suppression part 102A of the first pad spring 24A is in contact with the caliper 21. Specifically, in the suppression part 102A of the first pad spring 24A, the contact curved plate part 146A thereof is in contact with a first inclined surface 254a of a first inclined part 254 of a bridge part 222. At that time, in the suppression part 102A of the first pad spring 24A, mainly the intermediate curved plate part 144 deforms elastically as in the first embodiment. Then, the suppression part 102A of the first pad spring 24A presses the bridge part 222 in a direction perpendicular to the first inclined surface 254a. Specifically, in the suppression part 102A of the first pad spring 24A, mainly the intermediate curved plate part 144, the inclined plate part 145, and the contact curved plate part 146A press the caliper 21 in both directions to a disc rotation direction second end side and the disc radial direction outer side. In other words, in the suppression part 102A of the first pad spring 24A, mainly the intermediate curved plate part 144, the inclined plate part 145, and the contact curved plate part 146A suppress movement of the caliper 21 toward a disc rotation direction first end side and movement thereof toward the disc radial direction inner side. Here, the contact curved plate part 146A of the first pad spring 24A has a cylindrical shape extending in the disc axial direction. Also, the first inclined surface 254a of the bridge part 222 has a planar shape extending in the disc axial direction. Therefore, the contact curved plate part 146A of the first pad spring 24A and the first inclined surface 254a are in line contact with each other. This contact line extends in the disc axial direction.

Also, in the suppression part 102A of the first pad spring 24A, the distal end side curved plate part 272A thereof is in contact with a first lateral surface 253a of a first lateral part 253 of the bridge part 222. At that time, in the suppression part 102A of the first pad spring 24A, mainly the contact curved plate part 146A deforms elastically to bring the distal end side plate part 271A and the distal end side curved plate part 272A closer to the inclined plate part 145. Then, the suppression part 102A of the first pad spring 24A presses the bridge part 222 in a direction perpendicular to the first lateral surface 253a. That is, the suppression part 102A of the first pad spring 24A presses the caliper 21 to the disc rotation direction inner side. In other words, the suppression part 102A of the first pad spring 24A suppresses movement of the caliper 21 toward the disc rotation direction outer side. Specifically, in the suppression part 102A of the first pad spring 24A, mainly the contact curved plate part 146A, the distal end side plate part 271A, and the distal end side curved plate part 272A press the caliper 21 toward the disc rotation direction second end side. In other words, in the suppression part 102A of the first pad spring 24A, mainly the contact curved plate part 146A, the distal end side plate part 271A, and the distal end side curved plate part 272A suppress movement of the caliper 21 toward the disc rotation direction first end side. Here, the distal end side curved plate part 272A of the first pad spring 24A has a cylindrical shape extending in the disc axial direction. Also, the first lateral surface 253a of the bridge part 222 has a planar shape extending in the disc axial direction. Therefore, the distal end side curved plate part 272A of the first pad spring 24A and the first lateral surface 253a are in line contact with each other. This contact line extends in the disc axial direction.

As described above, the suppression part 102A of the first pad spring 24A suppresses both the movement of the caliper 21 in the disc rotation direction and the movement of the caliper 21 in the disc radial direction.

During braking of the disc brake 10A, a caliper main body 201 moves in the disc axial direction with respect to the mounting member 20. The contact curved plate part 146A of the first pad spring 24A has a cylindrical shape extending in the disc axial direction, and the first inclined surface 254a of the caliper main body 201 has a planar shape extending in the disc axial direction. Therefore, when the caliper main body 201 moves in the disc axial direction with respect to the mounting member 20, the first inclined surface 254a of the caliper main body 201 slides on the contact curved plate part 146A of the first pad spring 24A in the disc axial direction. Also, the distal end side curved plate part 272A of the first pad spring 24A has a cylindrical shape extending in the disc axial direction, and the first lateral surface 253a of the caliper main body 201 has a planar shape extending in the disc axial direction. Therefore, when the caliper main body 201 moves in the disc axial direction with respect to the mounting member 20, the first lateral surface 253a of the caliper main body 201 slides on the distal end side curved plate part 272A of the first pad spring 24A in the disc axial direction.

The disc brake 10A of the second embodiment achieves the same effects as in the first embodiment.

Also, in the disc brake 10A, the suppression part 102A of the first pad spring 24A is in contact with the first inclined part 254 and the first lateral part 253 of the bridge part 222 of the caliper 21. Thereby, suppression of movement of the caliper 21 outward in the disc rotation direction and inward in the disc radial direction by the suppression part 102A of the first pad spring 24A can be realized with a simple structure. Moreover, the suppression part 102A can have a higher suppressing force against movement toward the disc rotation direction outer side than the suppression part 102 of the first embodiment depending on the extent to which it is in contact with the first lateral part 253.

Similarly to the first embodiment, in the disc brake 10A of the second embodiment, both the movement of the caliper 21 in the disc rotation direction and the movement of the caliper 21 in the disc radial direction are suppressed by both the suppression part 102A of the first pad spring 24A and the suppression part of the second pad spring (not shown). Alternatively, the suppression part 102A may be provided in only one of the first pad spring 24A and the second pad spring (not shown). That is, the suppression part 102A may be provided in at least one of a pair of the first pad spring 24A and the second pad spring (not shown). Also, only one of the movement of the caliper 21 in the disc rotation direction and the movement of the caliper 21 in the disc radial direction may be suppressed by the suppression part 102A. That is, at least one of the movement of the caliper 21 in the disc rotation direction and the movement of the caliper 21 in the disc radial direction need only be suppressed by the suppression part 102A.

Also, in the disc brake 10A of the second embodiment, similarly to the first embodiment, a suppression part suppressing movement of the caliper 21 in a direction other than the disc axial direction may be provided separately from the first pad spring 24A, and a suppression part suppressing movement of the caliper 21 in a direction other than the disc axial direction may be provided separately from the second pad spring (not shown). In that case, one of the suppression parts is provided on the mounting member 20 at one end side of a first friction pad 26 and a second friction pad 27 in a longitudinal direction. Also, the other of the suppression parts is provided on the mounting member 20 at the other end side of the first friction pad 26 and the second friction pad 27 in the longitudinal direction.

### Third Embodiment

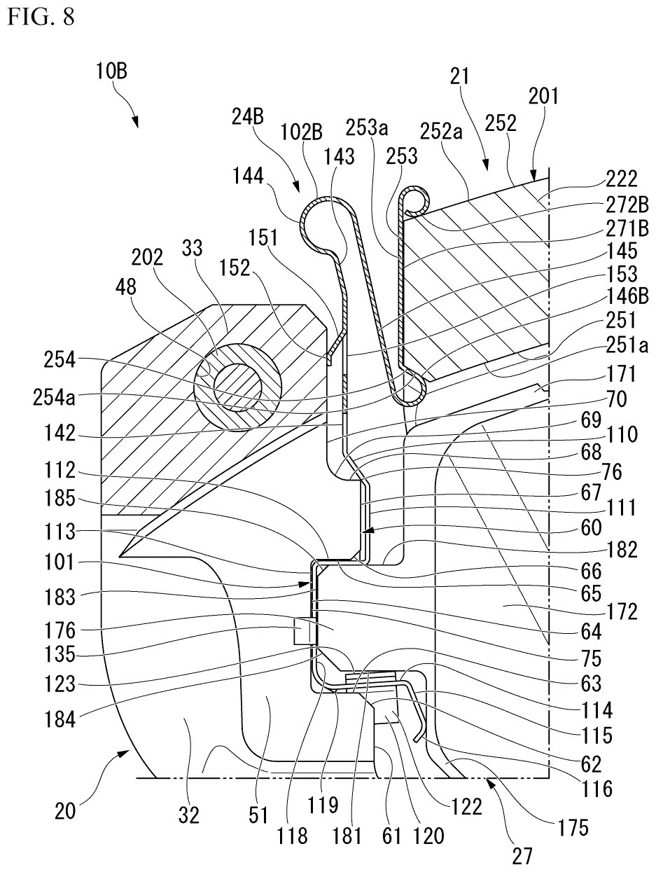

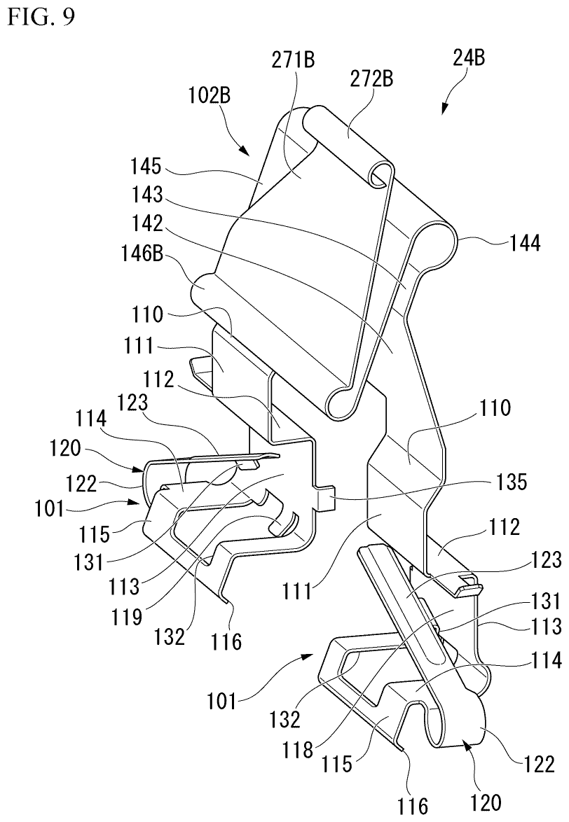

A third embodiment will be described mainly on the basis of FIGS. 8 and 9, focusing on the differences from the second embodiment. Further, parts common to those in the second embodiment will be denoted by the same terms and the same reference signs.

As shown in FIG. 8, instead of the first pad spring 24A of the second embodiment, a disc brake 10B of the third embodiment includes a first pad spring 24B (a pad spring, for example, a first pad spring, or for example, a first suppression member) that is partially different from the second pad spring 24A of the second embodiment. Also, although not shown in the drawings, instead of the second pad spring of the second embodiment, the disc brake 10B includes a second pad spring (a pad spring, for example, a second pad spring, or for example, a second suppression member) that is similar to the first pad spring 24B.

In the disc brake 10B, the first pad spring 24B and the second pad spring (not shown) are common parts having the same shape. Therefore, description will be made mainly by taking the first pad spring 24B as an example.

As shown in FIG. 9, the first pad spring 24B also has a mirror-symmetrical shape similarly to the first pad spring 24A. The first pad spring 24B is also formed by press-forming a single sheet of a metal plate material having a constant thickness similarly to the first pad spring 24A. The first pad spring 24B includes a pair of pad support parts 101 that are similar to those of the first and second embodiments, and a suppression part 102B that is partially different from the suppression part 102A of the second embodiment.

As shown in FIG. 8, the suppression part 102B includes a base end side plate part 142, an intermediate inclined plate part 143, an intermediate curved plate part 144, an inclined plate part 145, a protruding plate part 151, a contact plate part 152, and an opening 153, all of which are similar to those in the suppression part 102A. The suppression part 102B includes a contact curved plate part 146B that is slightly different from the contact curved plate part 146A, a distal end side plate part 271B that is slightly different from the distal end side plate part 271A, and a distal end side curved plate part 272B that is slightly different from the distal end side curved plate part 272A.

As shown in FIG. 9, the contact curved plate part 146B has a curved shape to form a cylindrical shape. The contact curved plate part 146B extends from an end edge portion of the inclined plate part 145 on a side opposite to the intermediate curved plate part 144. The contact curved plate part 146B extends to a side opposite to the intermediate curved plate part 144 in a thickness direction of the inclined plate part 145 while being separated from the intermediate curved plate part 144 in a thickness direction of an outer support plate part 112. Thereafter, the contact curved plate part 146B extends such that it becomes further away from the intermediate curved plate part 144 in the thickness direction of the inclined plate part 145 while approaching the intermediate curved plate part 144 in a thickness direction of the outer support plate part 112. Thereafter, the contact curved plate part 146B extends such that it approaches the intermediate curved plate part 144 in the thickness direction of the inclined plate part 145 while approaching the intermediate curved plate part 144 in the thickness direction of the outer support plate part 112. Thereafter, the contact curved plate part 146B extends in a flat plate shape to approach the intermediate curved plate part 144 in a thickness direction of the inclined plate part 145.

The distal end side plate part 271B extends from an end edge portion of the contact curved plate part 146B on a side opposite to an end edge portion continuous with the inclined plate part 145. The distal end side plate part 271B extends from the contact curved plate part 146B in a direction away from the outer support plate part 112 in the thickness direction of the outer support plate part 112. The distal end side plate part 271B extends from the contact curved plate part 146B so that it extends substantially parallel to the inclined plate part 145. A length of the distal end side plate part 271B in the thickness direction of the outer support plate part 112 is larger than that of the distal end side plate part 271A.

The distal end side curved plate part 272B has a curved shape to form a cylindrical shape. The distal end side curved plate part 272B extends from an end edge portion of the distal end side plate part 271B on a side opposite side to the contact curved plate part 146B. The distal end side curved plate part 272B extends from the distal end side plate part 271B to be separate from the inclined plate part 145 in a thickness direction of the distal end side plate part 271B while being separated from the contact curved plate part 146B in the thickness direction of the outer support plate part 112. Thereafter, the distal end side curved plate part 272B extends such that it becomes further away from the inclined plate part 145 in the thickness direction of the distal end side plate part 271B while approaching the contact curved plate part 146B in the thickness direction of the outer support plate part 112. Thereafter, the distal end side curved plate part 272B extends such that it approaches the inclined plate part 145 in the thickness direction of the distal end side plate part 271B while approaching the contact curved plate part 146B in the thickness direction of the outer support plate part 112.

A boundary line between the intermediate curved plate part 144 and the inclined plate part 145, a boundary line between the inclined plate part 145 and the contact curved plate part 146B, a boundary line between the contact curved plate part 146B and the distal end side plate part 271B, and a boundary line between the distal end side plate part 271B and the distal end side curved plate part 272B are parallel to each other. These boundary lines are parallel to an axis of a center of curvature of the cylindrical portion of the contact curved plate part 146B. These boundary lines are parallel to an axis of a center of curvature of the distal end side curved plate part 272B.

As shown in FIG. 8, the first pad spring 24B is attached to a mounting member 20 in the same manner as the first pad spring 24A. At that time, the first pad spring 24B is in a state in which the suppression part 102B is disposed on a disc radial direction outer side with respect to the pad support part 101. Also, at that time, the first pad spring 24B is positioned in a disc radial direction, a disc rotation direction, and a disc axial direction with respect to the mounting member 20.

In an attached state in which the first pad spring 24B is attached to the mounting member 20, the contact curved plate part 146B of the suppression part 102B extends from an end edge portion of the inclined plate part 145 on a side opposite to the intermediate curved plate part 144. Specifically, in this attached state, the contact curved plate part 146B is curved such that it extends from the inclined plate part 145 to a disc radial direction inner side and a disc rotation direction inner side, then extends to the disc radial direction outer side and the disc rotation direction inner side, and thereafter extends to the disc radial direction outer side and a disc rotation direction outer side. Thereafter, the contact curved plate part 146B extends in a flat plate shape to the disc rotation direction outer side. An axis of the center of curvature of the cylindrical portion of the contact curved plate part 146B extends in the disc axial direction. In other words, the contact curved plate part 146B has a cylindrical portion extending in the disc axial direction.

Also, in this attached state, in the suppression part 102B of the first pad spring 24B, the distal end side plate part 271B extends to the disc radial direction outer side from the end edge portion of the contact curved plate part 146B on a side opposite to an end edge portion continuous with the inclined plate part 145.

Also, in this attached state, in the suppression part 102B of the first pad spring 24B, the distal end side curved plate part 272B extends from an end edge portion of the distal end side plate part 271B on the disc radial direction outer side. In this attached state, the distal end side curved plate part 272B is curved such that it extends from the distal end side plate part 271B to the disc radial direction outer side and the disc rotation direction inner side, then extends to the disc radial direction inner side and the disc rotation direction inner side, and thereafter extends to the disc radial direction inner side and the disc rotation direction outer side. An axis of a center of curvature of the distal end side curved plate part 272B extends in the disc axial direction. In other words, the distal end side curved plate part 272B has a cylindrical shape extending in the disc axial direction.

The suppression part 102B of the first pad spring 24B is in contact with a caliper 21. Specifically, in the suppression part 102B of the first pad spring 24B, the contact curved plate part 146B thereof is in contact with a first inclined surface 254a of a first inclined part 254 of a bridge part 222. At that time, in the suppression part 102B of the first pad spring 24B, mainly the intermediate curved plate part 144 deforms elastically as in the second embodiment. Then, the suppression part 102B of the first pad spring 24B presses the bridge part 222 in a direction perpendicular to the first inclined surface 254a. Specifically, in the suppression part 102B of the first pad spring 24B, mainly the intermediate curved plate part 144, the inclined plate part 145, and the contact curved plate part 146B press the caliper 21 toward both a disc rotation direction second end side and the disc radial direction outer side. In other words, in the suppression part 102B of the first pad spring 24B, mainly the intermediate curved plate part 144, the inclined plate part 145, and the contact curved plate part 146B suppress movement of the caliper 21 toward a disc rotation direction first end side and movement thereof toward the disc radial direction inner side. Here, the contact curved plate part 146B of the first pad spring 24B and the first inclined surface 254a are in surface contact. This contact surface extends in the disc axial direction.

Also, in the suppression part 102B of the first pad spring 24B, the distal end side plate part 271B faces a first lateral surface 253a of a first lateral part 253, and the distal end side curved plate part 272B is in contact with an outer circumferential surface 252a of an outer circumferential part 252 of the bridge part 222. Thereafter, in the suppression part 102B of the first pad spring 24B, mainly the contact curved plate part 146B deforms elastically such that the distal end side plate part 271B is brought into surface contact with the first lateral surface 253a of the first lateral part 253 to press the distal end side plate part 271B against the first lateral part 253 on the disc rotation direction second end side. Also, at that time, in the suppression part 102B of the first pad spring 24B, mainly the distal end side curved plate part 272B deforms elastically such that the distal end side curved plate part 272B is brought into surface contact with the outer circumferential surface 252a of the outer circumferential part 252 to press the distal end side curved plate part 272B against the outer circumferential surface 252a on the disc radial direction inner side.

Then, in the suppression part 102B of the first pad spring 24B, mainly the intermediate curved plate part 144, the inclined plate part 145, and the contact curved plate part 146B press the caliper 21 toward both the disc radial direction outer side and the disc radial direction inner side. Also, in the suppression part 102B, the contact curved plate part 146B and the distal end side plate part 271B mainly press the caliper 21 toward the disc radial direction inner side. Also, in the suppression part 102B, the distal end side curved plate part 272B mainly presses the caliper 21 toward the disc radial direction inner side. In other words, the suppression part 102B suppresses movement of the caliper 21 toward the disc rotation direction outer side and the disc rotation direction inner side, and movement thereof toward the disc rotation direction outer side. Specifically, regarding the disc rotation direction, the suppression part 102B of the first pad spring 24B presses the caliper 21 toward the disc rotation direction second end side. In other words, regarding the disc rotation direction, the suppression part 102B of the first pad spring 24B suppresses movement of the caliper 21 toward the disc rotation direction first end side. Here, the distal end side curved plate part 272B of the first pad spring 24B has a cylindrical shape extending in the disc axial direction. Also, the outer circumferential surface 252a of the bridge part 222 has a curved surface shape extending in the disc axial direction. Therefore, the distal end side curved plate part 272B of the first pad spring 24B and the outer circumferential surface 252a are in line contact with each other. This contact line extends in the disc axial direction.

In this way, the suppression part 102B of the first pad spring 24B suppresses both the movement of the caliper 21 in the disc rotation direction and the movement of the caliper 21 in the disc radial direction. Moreover, regarding the disc radial direction, the suppression part 102B of the first pad spring 24B suppresses both the movement of the caliper 21 toward the disc radial direction inner side and the movement toward the disc radial direction outer side. The suppression part 102B supports the first inclined part 254 and the outer circumferential part 252 of the bridge part 222. The suppression part 102B is in contact with the first inclined part 254 and the outer circumferential part 252 to sandwich the bridge part 222 from both sides in the disc radial direction.

During braking of the disc brake 10B, a caliper main body 201 moves in the disc axial direction with respect to the mounting member 20. The contact curved plate part 146B of the first pad spring 24B extends in the disc axial direction, and the first inclined surface 254a of the caliper main body 201 has a planar shape extending in the disc axial direction. Therefore, when the caliper main body 201 moves in the disc axial direction with respect to the mounting member 20, the first inclined surface 254a of the caliper main body 201 slides on the contact curved plate part 146B of the first pad spring 24B in the disc axial direction.

Also, the distal end side plate part 271B of the first pad spring 24B has a planar shape extending in the disc axial direction, and the first lateral surface 253a of the caliper main body 201 extends in the disc axial direction. Therefore, when the caliper main body 201 moves in the disc axial direction with respect to the mounting member 20, the first lateral surface 253a of the caliper main body 201 slides on the distal end side plate part 271B of the first pad spring 24B in the disc axial direction.

Also, the distal end side curved plate part 272B of the first pad spring 24B has a cylindrical shape extending in the disc axial direction, and the outer circumferential surface 252a of the caliper main body 201 extends in the disc axial direction. Therefore, when the caliper main body 201 moves in the disc axial direction with respect to the mounting member 20, the outer circumferential surface 252a of the caliper main body 201 slides on the distal end side curved plate part 272B of the first pad spring 24B in the disc axial direction.

The disc brake 10B of the third embodiment achieves the same effects as in the first embodiment.

Also, in the disc brake 10B, the suppression part 102B of the first pad spring 24B supports the first inclined part 254 and the outer circumferential part 252 of the bridge part 222 of the caliper 21. Thereby, the suppression part 102B can suppress movement of the caliper 21 both inward in the disc radial direction and outward in the disc radial direction.

Similarly to the first and second embodiments, in the disc brake 10B of the third embodiment, both the movement of the caliper 21 in the disc rotation direction and the movement of the caliper 21 in the disc radial direction are suppressed by both the suppression part 102B of the first pad spring 24B and the suppression part of the second pad spring (not shown). Alternatively, the suppression part 102B may be provided in only one of the first pad spring 24B and the second pad spring (not shown). That is, the suppression part 102B may be provided in at least one of a pair of the first pad spring 24B and the second pad spring (not shown). Also, only one of the movement of the caliper 21 in the disc rotation direction and the movement of the caliper 21 in the disc radial direction may be suppressed by the suppression part 102B. That is, at least one of the movement of the caliper 21 in the disc rotation direction and the movement of the caliper 21 in the disc radial direction need only be suppressed by the suppression part 102B.

Also, in the disc brake 10B of the third embodiment, similarly to the first and second embodiments, a suppression part suppressing movement of the caliper 21 in a direction other than the disc axial direction may be provided separately from the first pad spring 24B, and a suppression part suppressing movement of the caliper 21 in a direction other than the disc axial direction may be provided separately from the second pad spring (not shown). In that case, one of the suppression parts is provided on the mounting member 20 at one end side of a first friction pad 26 and a second friction pad 27 in a longitudinal direction. Also, the other of the suppression parts is provided on the mounting member 20 at the other end side of the first friction pad 26 and the second friction pad 27 in the longitudinal direction.

### Fourth Embodiment

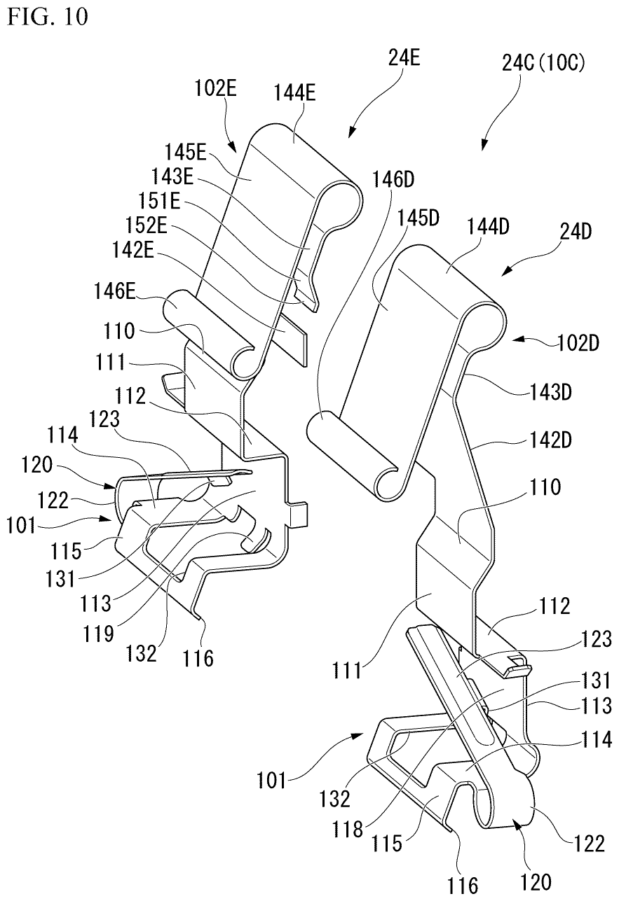

A fourth embodiment will be described mainly on the basis of FIG. 10, focusing on the differences from the first embodiment. Further, parts common to those in the first embodiment will be denoted by the same terms and the same reference signs.

As shown in FIG. 10, instead of the first pad spring 24 of the first embodiment, a disc brake 10C of the fourth embodiment includes a first pad spring set 24C that is partially different from the first pad spring 24. Also, although not shown, the disc brake 10C of the fourth embodiment includes a second pad spring set that is similar to the first pad spring set 24C instead of the second pad spring 25 of the first embodiment.

The first pad spring set 24C and the second pad spring set (not shown) are common parts having the same shape. Therefore, description will be made mainly by taking the first pad spring set 24C as an example.

The first pad spring set 24C has a shape in which the suppression part 102 of the first pad spring 24 of the first embodiment is divided into a suppression part 102D that is continuous with one pad support part 101 of the pair of pad support parts 101, and a suppression part 102E that is continuous with the other pad support part 101. Therefore, the first pad spring set 24C has two of a first pad spring 24D (a pad spring, for example, a first pad spring, or for example, a first suppression member) and a first pad spring 24E (a pad spring, for example, a first pad spring, or for example, a first suppression member). The first pad spring 24D and the first pad spring 24E have a mirror-symmetrical shape. The first pad spring 24D has one pad support part 101 of the pair of pad support parts 101 and the suppression part 102D that is continuous therewith. The first pad spring 24E has the other pad support part 101 of the pair of pad support parts 101 and the suppression part 102E that is continuous therewith.

The suppression part 102D of the first pad spring 24D includes a base end side plate part 142D, an intermediate inclined plate part 143D, an intermediate curved plate part 144D, an inclined plate part 145D, a contact curved plate part 146D, a protruding plate part (not shown), and a contact plate part (not shown).

The suppression part 102E of the first pad spring 24E includes a base end side plate part 142E, an intermediate inclined plate part 143E, an intermediate curved plate part 144E, an inclined plate part 145E, a contact curved plate part 146E, a protruding 5 plate part 151E, and a contact plate part 152E.

The base end side plate part 142D of the suppression part 102D is a part of the base end side plate part 142 of the first embodiment on one pad support part 101 side. The intermediate inclined plate part 143D of the suppression part 102D is a part of the intermediate inclined plate part 143 of the first embodiment on one pad support part 101 side. The intermediate curved plate part 144D of the suppression part 102D is a part of the intermediate curved plate part 144 of the first embodiment on one pad support part 101 side. The inclined plate part 145D of the suppression part 102D is a part of the inclined plate part 145 of the first embodiment on one pad support part 101 side. The contact curved plate part 146D of the suppression part 102D is a part of the contact curved plate part 146 of the first embodiment on one pad support part 101 side. The protruding plate part (not shown) of the suppression part 102D is a part of the protruding plate part 151 of the first embodiment on one pad support part 101 side. The contact plate part (not shown) of the suppression part 102D is a part of the contact plate part 152 of the first embodiment on one pad support part 101 side.

The base end side plate part 142E of the suppression part 102E is a part of the base end side plate part 142 of the first embodiment on the other pad support part 101 side. The intermediate inclined plate part 143E of the suppression part 102E is a part of the intermediate inclined plate part 143 of the first embodiment on the other pad support part 101 side. The intermediate curved plate part 144E of the suppression part 102E is a part of the intermediate curved plate part 144 of the first embodiment on the other pad support part 101 side. The inclined plate part 145E of the suppression part 102E is a part of the inclined plate part 145 of the first embodiment on the other pad support part 101 side. The contact curved plate part 146E of the suppression part 102E is a part of the contact curved plate part 146 of the first embodiment on the other pad support part 101 side. The protruding plate part 151E of the suppression part 102E is a part of the protruding plate part 151 of the first embodiment on the other pad support part 101 side. The contact plate part 152E of the suppression part 102E is a part of the contact plate part 152 of the first embodiment on the other pad support part 101 side.

The first pad spring 24D of the first pad spring set 24C is attached to an engaging part 60 (see FIG. 1) of an outer third connection part 51 on a disc rotation direction first end side. Also, the first pad spring 24E of the first pad spring set 24C is attached to the engaging part 60 (see FIG. 1) of an inner first connection part 46 on the disc rotation direction first end side. Therefore, the inner first pad spring 24E and the outer first pad spring 24D that is separate from the first pad spring 24E are provided on a mounting member 20 on the disc rotation direction first end side.

In the first pad spring set 24C, the suppression part 102D of the first pad spring 24D and the suppression part 102E of the first pad spring 24E are in contact with a caliper 21. Specifically, in the suppression part 102D of the first pad spring 24D, the contact curved plate part 146D is in contact with a first inclined surface 254a (see FIG. 4) of a first inclined part 254 of a bridge part 222. Also, in the suppression part 102E of the first pad spring 24E, the contact curved plate part 146E is in contact with the first inclined surface 254a (see FIG. 4) of the first inclined part 254 of the bridge part 222. At that time, the suppression part 102D of the first pad spring 24D and the suppression part 102E of the first pad spring 24E press the bridge part 222 similarly to the suppression parts 102 of the first embodiment. Also, at that time, the contact curved plate part 146D of the first pad spring 24D and the first inclined surface 254a are in line contact with each other, and the contact curved plate part 146E of the first pad spring 24E and the first inclined surface 254a are in line contact with each other.

In the second pad spring set (not shown) that is similar to the first pad spring set 24C, a second pad spring (a pad spring, for example, a second pad spring, or for example, a second suppression member) (not shown) that is similar to the first pad spring 24D is attached to the engaging part 60 (see FIG. 1) of an inner second connection part 47 on a disc rotation direction second end side. Also, in the second pad spring set, a second pad spring (a pad spring, for example, a second pad spring, or for example, a second suppression member) (not shown) that is similar to the first pad spring 24E is attached to the engaging part 60 (see FIG. 1) of an outer fourth connection part 52 on the disc rotation direction second end side.

The first pad spring set 24C is provided such that two of the first pad springs 24D and 24E correspond to the pair of the first friction pad 26 and the second friction pad 27. Also in the second pad spring set (not shown), two of the second pad spring that is similar to the first pad spring 24D and the second pad spring that is similar to the first pad spring 24E are provided to correspond to the pair of the first friction pad 26 and the second friction pad 27.

The disc brake 10C of the fourth embodiment achieves the same effects as in the first embodiment.

Moreover, in the disc brake 10C of the fourth embodiment, the first pad spring set 24C includes two of the first pad springs 24D and 24E. The second pad spring set (not shown) also includes two of the second pad spring that is similar to the first pad spring 24D and the second pad spring that is similar to the first pad spring 24E. Therefore, it is possible to impart different spring rigidities to the inner side and outer side according to a mass distribution of the mounting member 20. Therefore, a gradient can be given to a spring reaction force (suppression amount) on the inner side and outer side according to load applied to the suppression parts 102D and 102E. Thereby, a load distribution on the suppression parts 102D and 102E can be equalized, and a load (stress, strain) around the suppression parts 102D and 102E can be equalized. As a result, movement of the caliper 21 in the disc rotation direction and movement of the caliper 21 in the disc radial direction can be restricted only by a necessary amount on each of the inner side and the outer side.

Similarly to the first to third embodiments, in the disc brake 10C of the fourth embodiment, both the movement of the caliper 21 in the disc rotation direction and the movement of the caliper 21 in the disc radial direction are suppressed by both the suppression parts 102D and 102E of the first pad spring set 24C and the suppression parts of the second pad spring set (not shown). Alternatively, the suppression parts 102D and 102E may be provided in only one of the first pad spring set 24C and the second pad spring set (not shown). That is, the suppression parts 102D and 102E may be provided in at least one of a pair of the first pad spring set 24C and the second pad spring set (not shown). Also, only one of the movement of the caliper 21 in the disc rotation direction and the movement of the caliper 21 in the disc radial direction may be suppressed by the suppression parts 102D and 102E. That is, at least one of the movement of the caliper 21 in the disc rotation direction and the movement of the caliper 21 in the disc radial direction need only be suppressed by the suppression parts 102D and 102E.

Also, in the disc brake 10C of the fourth embodiment, similarly to the first to third embodiments, a suppression part suppressing movement of the caliper 21 in a direction other than the disc axial direction may be provided separately from the first pad springs 24D and 24E, and a suppression part suppressing movement of the caliper 21 in a direction other than the disc axial direction may be provided separately from the second pad springs (not shown). In that case, the suppression parts of the first pad springs are provided on the mounting member 20 at one end side of the first friction pad 26 and second friction pad 27 in a longitudinal direction. Also, the suppression parts of the second pad springs are provided on the mounting member 20 at the other end side of the first friction pad 26 and second friction pad 27 in the longitudinal direction.

As in the disc brake 10C of the fourth embodiment, the first pad springs 24A and 24B and the second pad springs (not shown) of the disc brakes 10A and 10B of the second and third embodiments may be divided into those on the inner side and outer side.

### Industrial Applicability

According to each of the above-described embodiments of the present invention, it is possible to provide a disc brake and a pad spring that can suppress a decrease in durability. Therefore, industrial applicability is high.

### REFERENCE SIGNS LIST

10, 10A to 10C Disc brake
11 Disc
11a First braking surface (surface)
11b Second braking surface (surface)
20 Mounting member
21 Caliper
24, 24A, 24B, 24D, 24E First pad spring (pad spring, for example, first pad spring, or for example, first suppression member)
25 Second pad spring (pad spring, for example, second pad spring, or for example, second suppression member)
26 First friction pad
27 Second friction pad
101 Pad support part
102, 102A, 102B, 102D, 102E Suppression part
221 Cylinder part
222 Bridge part
223 Claw part
231 Cylinder hole
251 Inner circumferential part
252 Outer circumferential part
253 First lateral part (lateral part)
254 First inclined part (inclined part)
255 Second lateral part (lateral part)
256 Second inclined part (inclined part)

1. A disc brake comprising:
a mounting member fixed to a non-rotating portion of a vehicle and provided to straddle an outer circumferential side of a disc;
a caliper provided on the mounting member to be movable in an axial direction of the disc;
a pair of friction pads provided on the mounting member to be movable and pressed against both sides of the disc by the caliper; and
a pair of pad springs provided on the mounting member, wherein
at least one of the pair of pad springs includes:
a pad support part supporting the friction pads; and
a suppression part suppressing at least one of movement of the caliper in a rotation direction of the disc and movement of the caliper in a radial direction of the disc.

2. The disc brake according to claim 1, wherein
a first pad spring, which is one of the pair of pad springs, suppresses at least one of movement of the caliper in the rotation direction of the disc and movement of the caliper in the radial direction of the disc, and
a second pad spring, which is the other of the pair of pad springs, suppresses at least one of movement of the caliper in the rotation direction of the disc and movement of the caliper in the radial direction of the disc.

3. The disc brake according to claim 2, wherein
the first pad spring is provided on the mounting member at one end side of the friction pads in a longitudinal direction and suppresses movement of the caliper in the rotation direction of the disc and movement of the caliper in the radial direction of the disc, and
the second pad spring is provided on the mounting member at the other end side of the friction pads in the longitudinal direction and suppresses movement of the caliper in the rotation direction of the disc and movement of the caliper in the radial direction of the disc.

4. The disc brake according to claim 2, wherein
two of the first pad springs are provided to correspond to the pair of friction pads, and
two of the second pad springs are provided to correspond to the pair of friction pads.

5. The disc brake according to claim 1, wherein
the caliper includes:
a cylinder part having a cylinder hole in which a piston pressing the friction pads is accommodated;
a bridge part having
an inner circumferential part provided to straddle an outer circumferential side of the disc from the cylinder part and which faces the friction pad side,
an outer circumferential part on a side opposite to the inner circumferential part,
a lateral part extending in the axial direction of the disc to be continuous with the outer circumferential part, and
an inclined part extending in the axial direction of the disc to be continuous with the lateral part and the inner circumferential part and inclined to a side of the inner circumferential part with respect to the lateral part when viewed from the axial direction of the disc; and
a claw part provided to face the cylinder part in an axial direction of the cylinder hole from the bridge part, and
the suppression part is in contact with the inclined part.

6. The disc brake according to claim 5, wherein the suppression part is in contact with the inclined part and the lateral part.

7. The disc brake according to claim 5, wherein the suppression part supports the inclined part and the outer circumferential part.

8. A disc brake comprising:
a mounting member fixed to a non-rotating portion of a vehicle and provided to straddle an outer circumferential side of a disc;
a caliper provided on the mounting member to be movable in an axial direction of the disc;
a pair of friction pads provided on the mounting member to be movable and pressed against both sides of the disc by the caliper;
a first suppression member provided on the mounting member at one end side of the friction pads in a longitudinal direction and configured to suppress at least one of movement of the caliper in a rotation direction of the disc and movement of the caliper in a radial direction of the disc; and
a second suppression member provided on the mounting member at the other end side of the friction pads in the longitudinal direction and configured to suppress at least one of movement of the caliper in the rotation direction of the disc and movement of the caliper in the radial direction of the disc.

9. A pad spring which is provided on a mounting member in a disc brake including the mounting member fixed to a non-rotating portion of a vehicle and provided to straddle an outer circumferential side of a disc, a caliper provided on the mounting member to be movable in an axial direction of the disc, and a pair of friction pads provided on the mounting member to be movable and pressed against both sides of the disc by the caliper, the pad spring comprising:
a pad support part supporting the friction pads; and
a suppression part suppressing at least one of movement of the caliper in a rotation direction of the disc and movement of the caliper in a radial direction of the disc.

10. The pad spring according to claim 9, wherein the suppression part suppresses movement of the caliper in the rotation direction of the disc and movement of the caliper in the radial direction of the disc.
